(19) United States
(12) Patent Application Publication
(10) Pub. No.: US 2026/0138206 A1
(43) Pub. Date: May 21, 2026

(54) Automatic Adaptive Control of Friction Stir Welding

(71) Applicant: Concurrent Tecnologies Corporation, Johnstown, PA (US)

(72) Inventors: Kevin COLLIGAN, Abbeville, LA (US); Johnathon Hunt, Trenton, MI (US)

(73) Assignee: Concurrent Tecnologies Corporation, Johnstown, PA (US)

(21) Appl. No.: 19/390,258

(22) Filed: Nov. 14, 2025

Related U.S. Application Data
(60) Provisional application No. 63/720,880, filed on Nov. 15, 2024.

(51) Int. Cl. B23K 20/12

(52) U.S. Cl. CPC B23K 20/123; B23K 20/121

(57) ABSTRACT

Embodiments relate to a friction stir welding apparatus. The apparatus includes a friction stir welding unit that rotates a welding tool about a spindle axis at a spindle rate of rotation (Sᵣ₋ₒ₋ₜ), causes the welding tool to travel in a direction perpendicular to the spindle axis at a travel speed (T_{speed}), and causes the welding tool to impart a downward force on a workpiece at a plunge force (P_{force}). A sensor module detects a spindle torque and generates a representative spindle torque signal. A control module receives the spindle torque signal and generates a command signal and/or recommendation signal to modulate the Sᵣ₋ₒ₋ₜ, the T_{speed}, and/or the P_{force} in response to the detected spindle torque. The control module generates the command signal and/or the recommendation signal to modulate the Sᵣ₋ₒ₋ₜ, the T_{speed}, and/or the P_{force} so that the detected spindle torque stays within a range of spindle torque values.

### CROSS-REFERENCE TO RELATED APPLICATIONS

This patent application relates to and claims the benefit of priority of U.S. provisional application No. 63/720,880, filed on Nov. 15, 2024, the entire contents of which is incorporated by reference.

### FIELD OF THE INVENTION

Embodiments can relate to techniques for modulating spindle rate of rotation, travel speed, and/or a plunge force based on spindle torque detected during a friction stir weld so as to minimize or prevent damage to the welding tool, minimize or prevent defects to a workpiece, and/or to improve or optimize weld productivity.

### BACKGROUND OF THE INVENTION

Friction stir welding is a process that can make use of frictional heat to cause plastic work on a workpiece. The process can include use of a tool tip that is rotated and pressed into a workpiece to strain and mix the workpiece material, where the frictional heat plasticizes the workpiece material that is being strained and mixed. The tool tip can also be traversed along a path of the workpiece. As it moves along the workpiece, the plasticized material may cool and consolidate to form the weld. With friction stir welding, a first workpiece can be placed adjacent a second workpiece and the tool tip can be caused to plasticize the regions that form the interface between the two workpieces. Upon cooling, the plasticized material at the interface consolidates to form a unitary member comprising both workpieces.

The control of friction stir welding is often limited to the control of the basic machine settings of spindle speed and travel speed, manual or automatic control of lateral alignment with the joint, and some method of controlling the shoulder/workpiece contact conditions, usually by controlling the plunge axis position or force. Weld quality is typically maintained by strict adherence to a qualified welding procedure, much like the way arc welding processes are qualified. However, a fundamental difference between arc welding processes and friction stir welding lies in the fact that friction stir welding is much more sensitive to the process boundary condition than arc processes. Changes in boundary conditions, for example, include things like changes in the workpiece geometry surrounding the joint and welding fixture, and welding tool or workpiece initial temperatures. Because of this sensitivity, it is often necessary to qualify the welding procedure along the full length of the intended joint on hardware that is fully representative of the intended product. It is not sufficient to simply qualify a particular welding tool, alloy, joint thickness, and machine settings in simple plates with constant boundary conditions. For very large or expensive products, the iterative nature of developing a qualified welding procedure can become cost prohibitive and will often require considerable expertise on the part of the welding engineer and machine operators.

The quality of the weld cannot always be directly observed during friction stir welding, since weld defects are often hidden internally. The two most common ways to non-destructively measure weld quality are radiographic inspection and ultrasonic inspection. Both methods are only suitable for use after the weld is completed.

Prior to the present invention, the only way to perform in-process control of weld quality was by observing outputs from the welding process that can be correlated to weld quality, then making changes to the welding machine settings to ensure consistent welding conditions despite changes in (and around) the welding process in real time. One such form of control is load control of the plunge axis to ensure adequate contact between the welding tool shoulder and the workpiece surface in spite of small changes in workpiece thickness. However, even this type of control is complicated by changing boundary conditions. An increase in weld zone temperature can possibly result in excessive tool depth which can result in the tool contacting the anvil on the back side of the joint.

Closed-loop temperature control has been demonstrated for maintaining constant welding conditions despite changing workpiece geometry or residual heat along the weld path. This technology typically uses a thermocouple that is embedded in the rotating welding tool, connected to a rotating transmitter. This way, the control system can continuously monitor the temperature of the welding tool and make changes to the spindle speed or spindle drive motor torque to keep the temperature at the desired setpoint. However, this method requires installation of a thermocouple, or other temperature measuring device, in the rotating welding tool and transmitting the measured temperature to a stationary receiver that is in communication with the welding machine controller.

Another problem with the automatic control of machine settings to maintain a constant welding tool temperatures lies in the potential for generating welds with poor quality based on exceeding the ability of the welding tool to plastically deform and suitably consolidate workpiece material at an excessively high rate. Each welding tool has limited ability to plastically deform and consolidate workpiece material based on the size of the features cut into the surface of the tool, referred to descriptively as the pitch capacity of the given tool. During operation, if the forward advance of the welding tool per revolution, the S_{Pitch}, is excessively high in comparison to the size of the welding tool features, these features fail to function as normal and welds with reduced quality can be produced. Therefore, while automatically modulating spindle speed or torque to hold a constant welding tool temperature, if the controller reduces the spindle speed, this necessarily increases the S_{Pitch}, which may ultimately exceed the pitch capacity of the welding tool design.

The present invention is directed toward overcoming one or more of the above-identified problems.

### SUMMARY OF THE INVENTION

An exemplary embodiment relates to a friction stir welding apparatus. The apparatus includes a friction stir welding (FSW) unit configured to rotate a welding tool about a spindle axis at a spindle rate of rotation (Sᵣ₋ₒ₋ₜ), cause the welding tool to travel in a direction essentially perpendicular to the spindle axis at a travel speed (T_{speed}), and cause the welding tool to impart a downward force on a workpiece at a plunge force (P_{force}). The apparatus includes a sensor module configured to detect a spindle torque and generate a spindle torque signal representative of the spindle torque. The apparatus includes a control module configured to receive the spindle torque signal and. The control module is configured to generate: 1) a command signal to modulate the Sᵣ₋ₒ₋ₜ, the T_{speed}, and/or the P_{force} in response to the detected spindle torque; and/or 2) a recommendation signal to modulate the Sᵣ₋ₒ₋ₜ, the T_{speed}, and/or the P_{force} in response to the detected spindle torque. The control module is configured to generate the command signal and/or the recommendation signal to modulate the Sᵣ₋ₒ₋ₜ, the T_{speed}, and/or the P_{force} so that the detected spindle torque stays within a range of spindle torque values.

In some embodiments, the range of spindle torque values is defined by an upper threshold spindle torque value and a lower threshold spindle torque value.

In some embodiments, the upper threshold spindle torque value is a spindle torque value corresponding to a flow stress for a material of the workpiece above which a defect in the workpiece is generated. In some embodiments, the lower threshold spindle torque value is a spindle torque value corresponding to a flow stress for a material of the workpiece below which a defect in the workpiece is generated.

In some embodiments, maintaining the detected spindle torque within the range defined by the upper threshold spindle torque value and the lower threshold spindle torque value generates no defects in the material of the workpiece due to flow stress effects, including for example, exceeding the hot workability limits of the workpiece material.

In some embodiments, the range of spindle torque values is defined by an upper threshold parameter value and a lower threshold parameter value. In some embodiments, the upper threshold parameter value is a measurement that is proportional to spindle torque above which a defect in the workpiece is generated. In some embodiments, the lower threshold spindle torque value is a measurement that is proportional to spindle torque below which a defect in the workpiece is generated.

In some embodiments, the modulation of the Sᵣ₋ₒ₋ₜ, the T_{speed}, and/or the P_{force} includes: increasing Sᵣ₋ₒ₋ₜ, decreasing T_{speed}, and/or decreasing P_{force} to decrease the detected spindle torque; and/or decreasing Sᵣ₋ₒ₋ₜ, increasing T_{speed}, and/or increasing P_{force} to increase the detected spindle torque.

In some embodiments, the modulation of the Sᵣ₋ₒ₋ₜ, the T_{speed}, and/or the P_{force} includes: 1) increasing/decreasing one or more of the Sᵣ₋ₒ₋ₜ, the T_{speed}, and/or the P_{force} while holding one or more constant; 2) increasing/decreasing one or more of the Sᵣ₋ₒ₋ₜ, the T_{speed}, and/or the P_{force} while allowing one or more to be uncontrolled; 3) increasing/decreasing any number of the Sᵣ₋ₒ₋ₜ, the T_{speed}, and/or the P_{force} simultaneously; 4) increasing/decreasing any number of the Sᵣ₋ₒ₋ₜ, the T_{speed}, and/or the P_{force} in a successive order; 5) increasing/decreasing any one of the Sᵣ₋ₒ₋ₜ, the T_{speed}, and/or the P_{force} as a primary modulation and one or more as a secondary modulation; 6) increasing/decreasing any one of the Sᵣ₋ₒ₋ₜ, the T_{speed}, and/or the P_{force} as a gross modulation and one or more as a fine tune modulation; 7) increasing/decreasing any one or more of the Sr-o-t, the T_{speed}, and/or the P_{force} within a set modulation range; and/or 8) increasing/decreasing any one or more of the Sᵣ₋ₒ₋ₜ, the T_{speed}, and/or the P_{force} as a function of another.

In some embodiments, the control module is configured to: 1) receive the spindle torque signal and generate the command signal in a feedback loop; and/or 2) receive the spindle torque signal and generate the recommendation signal in a feedback loop.

In some embodiments, the sensor module configured to also detect an in-plane force acting upon the welding tool when the welding tool is caused to perform work on a workpiece, the in-plane force being a force essentially normal to the spindle axis, wherein the sensor module generates an in-plane force signal representative of the in-plane force. The control module is configured to receive the in-plane force signal and generate: 1) a command signal to modulate the T_{speed} in response to the in-plane force signal; and/or 2) a recommendation signal to modulate the T_{speed} in response to the in-plane force signal.

In some embodiments, the control module is configured to set one or more limits on the T_{speed} or modulation of the T_{speed} based on the detected in-plane force.

An exemplary embodiment relates to a friction stir welding apparatus. The apparatus includes a friction stir welding (FSW) unit configured to rotate a welding tool about a spindle axis at a spindle rate of rotation (Sᵣ₋ₒ₋ₜ), cause the welding tool to travel in a direction essentially perpendicular to the spindle axis at a travel speed (T_{speed}), and cause the welding tool to impart a downward force on a workpiece at a plunge force (P_{force}). The apparatus includes a sensor module configured to detect a spindle torque and generate a spindle torque signal representative of the spindle torque. The apparatus includes a control module configured to receive the spindle torque signal and generate: 1) a command signal to modulate the P_{force} in response to the detected spindle torque; and/or 2) a recommendation signal to modulate the P_{force} in response to the detected spindle torque. The control module is configured to generate the command signal and/or the recommendation signal to modulate the P_{force} so that one or more of the following is held at a constant value: 1) an excess shoulder pressure; 2) a measurement parameter that is proportional to P_{force}; 3) a measurement parameter that is proportional to spindle torque; or 4) a measurement parameter that is proportional to a dimension of the welding tool. Excess shoulder pressure is achieved by maintaining a shoulder pressure at a fixed value greater than flow stress. Shoulder pressure=(P_{force}/shoulder area)−flow stress. Shoulder area is an area of a shoulder of the welding tool. Flow stress is a measure of an average contact shear stress at an interface between the welding tool and the workpiece.

An exemplary embodiment relates to a friction stir welding apparatus. The apparatus includes a friction stir welding (FSW) unit configured to rotate a welding tool about a spindle axis at a spindle rate of rotation (Sᵣ₋ₒ₋ₜ), cause the welding tool to travel in a direction perpendicular to the spindle axis at a travel speed (T_{speed}), and cause the welding tool to impart a downward force on a workpiece at a plunge force (P_{force}). The apparatus includes a sensor module configured to detect: 1) a spindle torque and generate a spindle torque signal representative of the spindle torque; 2) an in-plane force and generate an in-plane force signal representative of the in-plane force; and 3) a P_{force}, used to calculate an excess shoulder pressure and generate an excess shoulder pressure signal representative of the excess shoulder pressure. The apparatus includes a control module configured to receive the spindle torque signal, the in-plane force signal, and/or the excess shoulder pressure signal and generate: 1) a command signal to modulate the Sᵣ₋ₒ₋ₜ, the T_{speed}, and/or the P_{force} in response to the detected spindle torque, the detected in-plane force, and/or the detected excess shoulder pressure; and/or 2) a recommendation signal to modulate the Sᵣ₋ₒ₋ₜ, the T_{speed}, and/or the P_{force} in response to the detected spindle torque the detected in-plane force, and/or the detected excess shoulder pressure. The control module is configured to generate the command signal and/or the recommendation signal to modulate the Sᵣ₋ₒ₋ₜ, the T_{speed}, and/or the P_{force} so that: 1) the detected spindle torque stays within a range of spindle torque values; and 2) the detected in-plane force stays within a range of in-plane force values.

In some embodiments, the control module is configured to: 1) receive the spindle torque signal, the in-plane signal, and/or the excess shoulder pressure signal, and generate the command signal in a feedback loop; and/or 2) receive the spindle torque signal, the in-plane signal, and/or the excess shoulder pressure signal, and generate the recommendation signal in a feedback loop.

In some embodiments, the control module is configured to hold one or more of the Sᵣ₋ₒ₋ₜ, the T_{speed}, and the P_{force} constant while modulating one or more of the Sᵣ₋ₒ₋ₜ, the T_{speed}, and the P_{force}.

In some embodiments, the control module is configured to increase the T_{speed} to generate a predetermined in-plane force, modulate the Sᵣ₋ₒ₋ₜ and/or the P_{force} while holding the T_{speed} at a value that maintains the predetermined in-plane force.

In some embodiments, the predetermined in-plane force is a maximum in-plane force that will not damage the welding tool, will not result in premature failure of the welding tool, and/or achieve optimum weld productivity.

In some embodiments, the control module is configured implement a closed loop control to receive the spindle torque signal and generate the command signal and/or the recommendation signal.

In some embodiments, the control module is configured to implement a closed loop control to receive the spindle torque signal and generate the command signal and/or the recommendation signal under a closed loop control operation.

In some embodiments, the control module is configured to implement a closed loop control to receive the spindle torque signal and generate the command signal and/or the recommendation signal under a closed loop control operation.

An exemplary embodiment relates to a method for controlling a friction stir weld. The method involves initiating spindle speed, travel speed, and plunge force for a welding tool that is engaged with a workpiece. The method involves controlling flow stress experienced at an interface between the welding tool and the workpiece by: 1) modulating spindle speed only; 2) modulating spindle speed and travel speed, each being modulated within predefine operating limits, and each being modulated independently of the other; 3) modulating spindle speed and travel speed, each being modulated within predefine operating limits, and modulation of one is dependent on modulation of the other by imposing a relationship between spindle speed modulation and travel speed modulation; or 4) manipulating plunge axis position to modulate plunge force.

In some embodiments, controlling flow stress involves modulating spindle speed, travel speed, and/or plunge force to maintain a constant spindle torque.

In some embodiments, the method involves maintaining a constant workpiece temperature at the interface between the welding tool and the workpiece by maintaining the constant spindle torque.

An exemplary embodiment relates to a friction stir welding apparatus. The apparatus includes a friction stir welding (FSW) unit configured to rotate a welding tool about a spindle axis at a spindle rate of rotation (Sᵣ₋ₒ₋ₜ) and at a spindle pitch (S_{pitch}), cause the welding tool to travel in a direction perpendicular to the spindle axis at a travel speed (T_{speed}), and cause the welding tool to impart a downward force on a workpiece at a plunge force (P_{force}). The apparatus includes a sensor module configured to detect: a spindle torque and generate a spindle torque signal representative of the spindle torque, a welding tool temperature and generate a welding tool temperature signal representative of the welding tool temperature, and/or a flow stress and generate a flow stress signal representative of the flow stress. The apparatus includes a control module configured to receive the spindle torque signal, the welding tool temperature signal, and/or the flow stress signal. The control module generates a command signal to modulate the Sᵣ₋ₒ₋ₜ, the T_{speed}, the P_{force}, and/or the S_{pitch} in response to the detected spindle torque, welding tool temperature, and/or flow stress. In addition or in the alternative, the control module generates a recommendation signal to modulate the Sᵣ₋ₒ₋ₜ, the T_{speed}, the P_{force}, and/or the S_{pitch} in response to the detected spindle torque, welding tool temperature, and/or flow stress. The control module is configured to generate the command signal and/or the recommendation signal to modulate the Sᵣ₋ₒ₋ₜ, the T_{speed}, the P_{force}, and/or the S_{pitch} so that the detected spindle torque stays within a range of spindle torque values.

In some embodiments, the control module is configured to modulate the Sᵣ₋ₒ₋ₜ, the T_{speed}, the P_{force}, and/or the S_{pitch} by holding any one or combination of them at a constant value. In some embodiments, the control module is configured to modulate the Sᵣ₋ₒ₋ₜ, the T_{speed}, the P_{force}, and/or the S_{pitch} by maintaining any one or combination of them within a range of values. In some embodiments, the control module is configured to modulate two or more of the Sᵣ₋ₒ₋ₜ, the T_{speed}, the P_{force}, and/or the S_{pitch} in a constant ratio with respect to each other.

In some embodiments, the range of values for the Sᵣ₋ₒ₋ₜ is a range defined by a Sᵣ₋ₒ₋ₜ setpoint, a Sᵣ₋ₒ₋ₜ minimum, and a Sᵣ₋ₒ₋ₜ maximum. The range of values for the T_{speed} is a range defined by a T_{speed} setpoint, a T_{speed} minimum, and a T_{speed} maximum. The range of values for the P_{force} is a range defined by a P_{force} setpoint, a P_{force} minimum, and a P_{force} maximum. The range of values for the S_{pitch} is a range defined by a S_{pitch} setpoint, a S_{pitch} minimum, and a S_{pitch} maximum.

In some embodiments, the control module is configured to calculate a temperature at an interface between the welding tool and the workpiece based on the measured spindle torque, welding tool temperature, and flow stress.

In some embodiments, the control module is configured to monitor changes in thermal boundary conditions based on the temperature at the welding tool/workpiece interface. The control module is configured to modulate the Sᵣ₋ₒ₋ₜ, the T_{speed}, the P_{force}, and/or the S_{pitch} to maintain weld quality with changes in thermal boundary conditions.

While potential advantages are made possible by technical solutions offered herein, they are not required to be achieved. Embodiments of the presently disclosed system and method can be implemented to achieve technical advantages, whether or not these potential advantages, individually or in combination, are sought or achieved.

Further features, aspects, objects, advantages, and possible applications of the present invention will become apparent from a study of the exemplary embodiments and examples described below, in combination with the Figures, and the appended claims. One skilled in the art will readily appreciate that the embodiments disclosed herein are not mutually exclusive, and features from various embodiments may be combined or interchanged with features from other embodiments, which are all within the scope of the present invention.

### BRIEF DESCRIPTION OF THE DRAWINGS

The above and other objects, aspects, features, advantages and possible applications of the present invention will be more apparent from the following more particular description thereof, presented in conjunction with the following drawings, in which:

FIG. 1 shows an exemplary friction stir welding control system.

FIG. 2 shows an exemplary 6-in fishbone panel design with a weld path on the centerline of the panel from left to right.

FIG. 3 shows exemplary 3-in fishbone panel welds, with only shoulder contact control (left) and with torque control, manipulating both spindle speed and travel speed (right), 1-in thick 7075-T6 aluminum friction stir weld.

FIG. 4 shows a map of machine parameters from a data set, in terms of spindle speed and travel speed (left) and in terms of surface velocity and volumetric flowrate (right).

FIG. 5 shows flow stress vs. surface velocity.

FIG. 6 shows flow stress response surface planes by a data set cohort.

FIG. 7 shows an exemplary friction stir welding system.

FIG. 8 shows flow stress, lateral probe pressure, and total flash as a function of average surface velocity, 1.27 mm/s travel speed, 25-mm 7075-T6 aluminum, and averages from multiple weld segments.

FIG. 9 shows flow stress as a function of inverse surface velocity, 25-mm 7075-T6 aluminum at 1.27 mm/s travel speed.

FIG. 10 is a scatter plot of flow stress as a function of volumetric flowrate and inverse surface velocity, 25 mm 7075-T6 FSW.

FIG. 11 shows typical surface-tearing observation, crown surface (left) and macro section (right), 25 mm 7075-T6, 20.1 MPa average flow stress.

FIG. 12 shows a decision tree analysis of shoulder pressure minus flow stress (SP-FS), all welds in 25-mm 7075-T6.

FIG. 13 shows a 75-mm reduced width section without flow stress control (left) and with flow stress control (right) at a flow stress of about 31 MPa, 25-mm 7075-T6 aluminum plate.

FIG. 14 shows transverse macro section, 25-mm 7075-T6 at 100 mm width, 31.4 MPa flow stress.

FIG. 15 shows an exemplary flow stress control algorithm, with spindle speed modulation only.

FIG. 16 shows an exemplary flow stress control algorithm, with spindle speed and travel speed modulation within limits.

FIG. 17 shows an exemplary flow stress control with added excess shoulder pressure control.

FIG. 18 shows an exemplary flow stress control with weld pitch control.

FIG. 19 shows an exemplary flow stress control based on a generalized adaptive control algorithm.

FIG. 20 shows an exemplary adaptive control with modified pitch control in response to a restricted boundary condition.

FIG. 21 shows an exemplary adaptive control main algorithm with modified pitch control, with subroutines for “hot” and “cold” conditions.

FIG. 22 shows an exemplary adaptive control algorithm with modified pitch control for a “cold” conditions subroutine.

FIG. 23 shows an exemplary adaptive control algorithm with modified pitch control for a “hot” conditions subroutine.

FIG. 24 shows summary of welds made in 25-mm 7075-T6 aluminum with notations of volumetric defects observed.

FIG. 25 shows Test Series 1 average flow stress, lateral probe pressure and energy density as a function of average surface velocity, from welds in 25-mm 7075-T6 aluminum, all made at 1.27 mm/s travel speed (535 mm\hat{ }3/s volumetric flowrate).

FIG. 26 shows a macro section from an exemplary weld in 7075-T6 aluminum, made at 148 rev/min spindle speed (0.157 m/s average surface velocity) and 1.27 mm/s travel speed (535 mm\hat{ }3/s volumetric flowrate).

FIG. 27 is an image showing volumetric defect observed in a weld with low energy density.

FIG. 28 shows a macro section from a weld made at 1.27 mm/s travel speed and 207 rev/min spindle speed (0.219 m/s average surface velocity), showing (a) non-uniform region in upper SZ (cross reference FIG. 2), (b) upturned grains just outside the SZ, and (c) influx of material from retreating side.

FIG. 29 shows a macro section from weld made at 1.27 mm/s travel speed and 246 rev/min spindle speed (0.261 m/s average surface velocity), showing (a) volumetric defect in upper SZ (reference FIG. 2), (b) minimal evidence of shoulder in SZ, and (c) influx of material from retreating side.

FIG. 30 shows change in upper advancing side SZ shape, general appearance at 0.157 m/s surface velocity and below (left), and appearance at 0.178 m/s surface velocity and above (right).

FIG. 31 shows Test Series 2 average flow stress, lateral probe pressure, excess shoulder pressure, heat flux, and energy density as a function of volumetric flowrate from welds in 25-mm 7075-T6 aluminum, all made at 148 rev/min spindle speed (0.157 m/s average surface velocity) and with all welds made in position control.

FIG. 32 shows a macro section from a weld made at 148 rev/min spindle speed and 0.42 mm/s travel speed (178 mm\hat{ }3/s volumetric flowrate), showing scattered volumetric defects in upper SZ.

FIG. 33 shows a macro section from a weld made at 1.91 mm/s travel speed (779 mm\hat{ }3/s volumetric flow rate) and 148 rev/min spindle speed (0.157 m/s average surface velocity) which exhibited the maximum ultimate tensile strength of 440 MPa.

FIG. 34 shows Test Series 3 average flow stress, lateral probe pressure, excess shoulder pressure and energy density from welds in 25-mm 7075-T6 aluminum, all made at 89 rev/min spindle speed (0.095 m/s average surface velocity) and with welds made in load control only.

FIG. 35 shows a macro section from a weld made at 1.48 mm/s travel speed (621 mm\hat{ }3/s volumetric flowrate) and 89 rev/min spindle speed (0.095 m/s average surface velocity) with detail of advancing side SZ cluster of small volumetric defects.

FIG. 36 shows a macro section from a weld made at 1.91 mm/s travel speed (800 mm\hat{ }3/s volumetric flow rate) and 89 rev/min spindle speed (0.095 m/s average surface velocity) which exhibited volumetric defects in the upper advancing side of the SZ and in the root of the SZ.

FIG. 37 shows Test Series 4 average flow stress, lateral probe pressure, excess shoulder pressure, heat flux, and energy density from welds in 25-mm 7075-T6 aluminum, all made at 227 rev/min spindle speed (0.240 m/s average surface velocity) and made in load control. All welds had gross volumetric defects in the upper SZ, with severity decreasing with increasing welding speed.

FIG. 38 shows a contour plot of flow stress as a function of surface velocity and volumetric flowrate, where procedures with volumetric defects indicated 25-mm 7075-T6 FSW.

### DETAILED DESCRIPTION OF THE INVENTION

The following description is of an embodiment(s) presently contemplated for carrying out the present invention. This description is not to be taken in a limiting sense, but is made merely for the purpose of describing the general principles and features of the present invention. The scope of the present invention should be determined with reference to the claims.

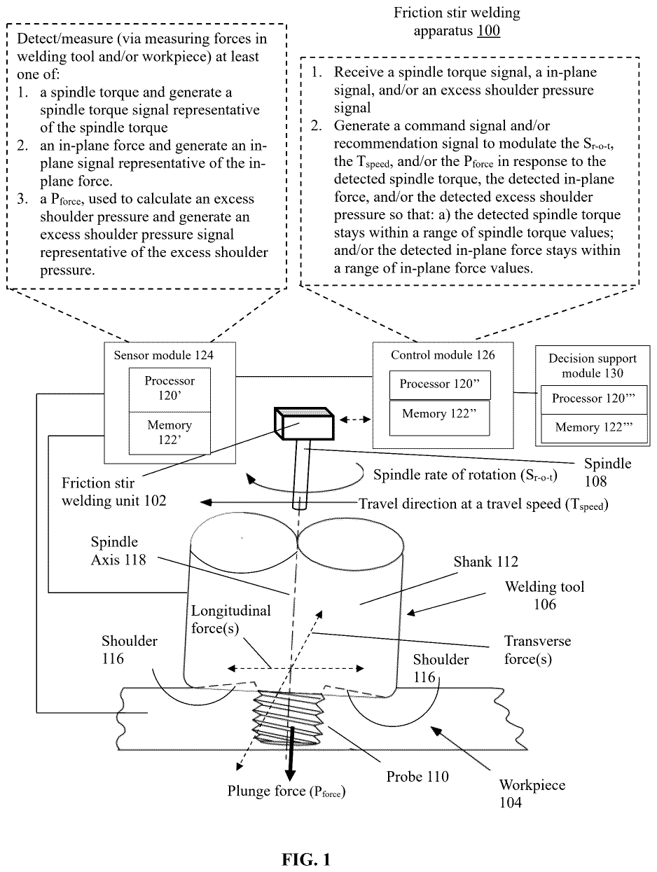

Referring to FIG. 1, embodiments can relate to a friction stir welding (FSW) apparatus 100. Some embodiments may refer to the FSW apparatus 100 as a system. The friction stir welding apparatus 100 can include a FSW unit 102 configured to use frictional heat to cause plastic work on a workpiece 104. The FSW unit 102 can include a rotary motor with a spindle 108 that can be mechanically coupled to a welding tool 106. The welding tool 106 can have a pin or probe 110 at a distal end thereof. The welding tool 106 is rotated by the rotary motor via the spindle 108, and the probe 110 is pressed into a workpiece 104 to strain and mix the workpiece material, where the frictional heat plasticizes the workpiece material that is being strained and mixed. The welding tool 106 can also be traversed along a path of the workpiece 104. As it moves along the workpiece 104, the plasticized material cools and consolidates to form a weld.

The welding tool 106 can include a shank 112 having a longitudinal axis that is coaxial with a longitudinal axis of the spindle 108. The shank 112 can be configured to reduce in radius (e.g., steps radially in towards the longitudinal axis, wherein the step inward is perpendicular to the longitudinal axis). The step inward can form a planar segment that leads to the probe 110.

This planar segment can form a shoulder 116 of the welding tool 106. The welding tool 106 can have one or more shoulders 116.

The FSW unit 102 can be configured to rotate a welding tool about the spindle axis 118 at a spindle rate of rotation (Sᵣ₋ₒ₋ₜ). The FSW unit 102 can be configured to cause the welding tool 106 to travel in a direction perpendicular to the spindle axis at a travel speed (T_{speed}). The FSW unit 102 can be configured to cause the welding tool 106 to impart a downward force on the workpiece 104 at a plunge force (P_{force}).

The FSW unit 102 can be a computerized unit (e.g., can include one or more processors 120, memories 122, processing modules, other control and communications circuitry, etc.).

Embodiments disclosed herein will also discuss use of components such as sensors, sensor modules, controllers, control modules, etc. Any of these components can include one or more processors 120, one or more memories 122, one or more processing modules, other control and communications circuitry, etc. The memory(ies) 122 can be operatively associated with the processor(s) 120. The memory(ies) 122 can have instructions stored thereon that when executed by the processor(s) 120 can cause the processor(s) 120 to carry out one or more of the functions disclosed herein.

A processor 120 can be any of the processors 120 disclosed herein. The processor 120 can be part of or in communication with a machine (logic, one or more components, circuits (e.g., modules), or mechanisms). The processor 120 can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors 120 herein can include any one or combination of a Graphics Processing Unit (GPU), a Field Programmable Gate Array (FPGA), a Central Processing Unit (CPU), etc. The processor 120 can include one or more processing modules. A processing module can be a software or firmware operating module configured to implement any of the method steps disclosed herein. The processing module can be embodied as software and stored in memory 122, the memory 122 being operatively associated with the processor 120. A processing module can be embodied as a web application, a desktop application, a console application, etc.

The processor 120 can include or be associated with a computer or machine readable medium. The computer or machine readable medium can include memory 122. The computer or machine readable medium can be configured to store one or more instructions thereon. The instructions can be in the form of algorithms, program logic, a model, etc. that cause the processor 120 to perform any of the functions described herein.

Any of the memory 122 discussed herein can be computer readable memory configured to store data. The memory 122 can include a volatile or non-volatile, transitory or non-transitory memory, and be embodied as an in-memory, an active memory, a cloud memory, etc. Embodiments of the memory 122 can include a processor module and other circuitry to allow for the transfer of data to and from the memory 122, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor 120 can be in communication with other processors of other devices (e.g., a computer device, a desktop computer, a laptop computer, a computer system, etc.). Any of those other devices can include any of the exemplary processors disclosed herein. Any of the processors 120 can have transceivers or other communication devices/circuitry to facilitate transmission and reception of wireless signals. Any of the processors 120 can include an Application Programming Interface (API) as a software intermediary that allows two applications to talk to each other. Use of an API can allow software of the processor 120 of the apparatus 100 to communicate with software of the processor 120 of the other device(s), if the processor 120 of the apparatus 100 is not the same processor of the device.

Any data transmission between the processor 120 and memory 122, between the processor 120 of one component and the processor 120 of another component, etc. can be via a pull operation (e.g., the processor 120 can pull the data) or a push operation (e.g., the data can be pushed to the processor 120). The processor 120 can receive the data in steaming format, or store it in memory 122 before being processed. In addition, embodiments of the algorithm, model, etc. disclosed herein can be developed as an application software (an “App”) to be implemented on a processor 120 of a device. The App can be sent via a steaming format, or the App can be sent and stored on a memory 122 associated with or accessed by the device.

As noted herein, the processor 120 can be configured to be a component of, used in combination with, or in communication with another device/system—e.g., this can include the processor 120 being part of the device/system, the device/system being part of the processor 120, the processor 120 in communication with the device/system, etc. “Being part of” can include being on a same substrate or integrated circuit.

While exemplary embodiments may describe and/or illustrate one processor 120 and one memory 122 for a component, it is understood that the component can include any number of processors 120 and memories 122.

FSW apparatus 100 can include one or more sensor modules 124, which can have a processor 120′ and a memory 122′. The sensor module 124 can be configured to detect a spindle torque. The sensor module 124 can be configured to generate a spindle torque signal representative of the spindle torque. The spindle torque signal can be stored in memory 122′ and/or transmitted to another component of the apparatus 100.

The sensor module 124 can be configured to measure and/or detect force, motion, pressure, temperature, acceleration, etc. For instance, the sensor module 124 can measure/detect spindle 108 torque, welding tool 106 temperature, flow stress, spindle 108 rate of rotation, spindle 108 pitch, travel speed of the welding tool 106, plunge force, etc. Any of the sensor modules 124 can include one or more force sensors, motions sensors, torque sensors, accelerometers, etc. Exemplary embodiments of the sensor module 124 include force sensor (e.g., measurement or monitoring device configured to convert mechanical forces (e.g., weight, tension, compression, torque, strain, stress, or pressure) into electrical signals that represent magnitudes, vectors, etc. of the force). These can be capacitive, inductive, piezoelectric, piezoresistive, contact resistance, etc. style sensors. For instance, a sensor module 124 can include plural contact resistance force sensors (e.g., each sensor comprising a conductive sheet composed of a matrix of electrically conductive and non-conductive particles that alter the resistance of the sheet in response to applied force) that measure magnitudes of forces at different points and from different directions and stores the magnitudes in an array in a memory 122′ of the sensor module 124. The magnitudes in the array can be converted to force vector representations, which can allow a processor 120′ of the sensor module 124 to calculate vectors sums to represent the force(s) being measured.

The FSW apparatus 100 can include one or more control modules 126, which can have a processor 120″ and a memory 122″. The control module 126 can be configured to receive the spindle torque signal (e.g., receive it directly from the sensor module 124 as the signals are being generated, pull the signal from the sensor memory 122 at predetermined times, the signal can be pushed from the sensor module 124 at predetermine times, etc.). The control module 126 can be in communication with the FSW unit 102 so as to either control the FSW unit 102, control aspects of the FSW unit 102, provide feedback to the FSW unit 102, provide recommendations to the FSW unit 102, etc. For instance, upon receiving the spindle torque signal, the control module 126 can generate a command signal to modulate the Sᵣ₋ₒ₋ₜ, the T_{speed}, and/or the P_{force} in response to the detected spindle torque. In addition, or in the alternative, the control module 126 can generate a recommendation signal for modulating the Sᵣ₋ₒ₋ₜ, the T_{speed}, and/or the P_{force} in response to the detected spindle torque. The command signal and/or the recommendation signal can be sent to the FSW unit 102, a computer in communication with the FSW unit 102, etc. The command signal can override other controls of the FSW unit 102, augment control of the FSW unit 102, or supplement control of the FSW unit 102, etc. The recommendation signal can be presented (via audio, textual, video, graphical display, etc.) to an operator of the FSW unit 102 to recommend a modulation of the Sᵣ₋ₒ₋ₜ, the T_{speed}, and/or the P_{force}. The FSW unit 102 can have display functions to facilitate this or the recommendation signal can be sent to a computer device that can display the same. It is contemplated for the command signal and/or the recommendation signal to modulate the Sᵣ₋ₒ₋ₜ, the T_{speed}, and/or the P_{force} so that the detected spindle torque stays within a range of spindle torque values. This range will be discussed in more detail later, but it is contemplated for the range to be set such that the spindle torque experienced does not (or at least minimizes) reflect welding conditions that may produce defects in the workpiece 104, does not (or at least minimizes) damage to the welding tool 106, and/or improves or maximizes weld productivity.

The recommendation signal can be or include an alert to notify the operator that a modulation should occur. In addition, or in the alternative, the control module 126 can transmit the recommendation signal to a decision support module 130, which can have a processor 120′″ and a memory 122′″. The memory 122′″ has computer logic, predictive modeling algorithm (e.g., multivariate analysis predictive model regression, model, time series model, etc.), machine learning algorithm (e.g., neural networks, decision trees, random forests, etc.), etc. that is accessed by the processor 120′″ to analyze the recommendation signal, consider one or more other factors, and generate an output. The output is an optimized output weighing all of the factors, and can be transmitted back to the control module 126 to allow the control module 126 to use the output as part of the feedback to the FSW unit 102.

The range of spindle torque values can be defined by an upper threshold spindle torque value and a lower threshold spindle torque value. For instance, the upper threshold spindle torque value can be a spindle torque value corresponding to a flow stress for a material of the workpiece 104 above which a defect in the workpiece 104 may be generated. The lower threshold spindle torque value can be a spindle torque value corresponding to a flow stress for a material of the workpiece 104 below which a defect in the workpiece 104 is more likely to be generated. The flow stress values corresponding to defect generation for purposes of setting the threshold values can be determined empirically (e.g., based on historical data about certain material compositions, chemistries, crystallography, geometry of the workpiece 104, the welding tool 106, etc.). Datasets of this empirical data can be stored in memory 122″ and current data of the current workpiece before and/or during the weld can be retrieved from the FSW unit 102 and/or the sensor module 124 which can then be compared to the datasets to ascertain which appropriate thresholds should be used. This can be done automatically and dynamically by the control module 126. The determination of the threshold spindle torque values can be determined via an algorithm, regression analysis, multivariant analysis, a machine learning model, etc. stored in the memory 122″ and implemented by the processor 120″ As a non-limiting example, the range of spindle torque values can be defined by an upper threshold parameter value and a lower threshold parameter value. The upper threshold parameter value can be a measurement that is proportional to spindle torque above which a defect in the workpiece 104 is generated, and the lower threshold spindle torque value can be a measurement that is proportional to spindle torque below which a defect in the workpiece 104 is generated.

As can be appreciated, maintaining the detected spindle torque within the range defined by the upper threshold spindle torque value and the lower threshold spindle torque value can be done so that no defects are generated in the material of the workpiece 104 due to inappropriate flow stress. Maintain the detected spindle torque within the range can involve modulating operating parameters of the FSW unit 102. This can involve modulating Sᵣ₋ₒ₋ₜ, the T_{speed}, and/or the P_{force}. For instance, spindle torque can be decreased by increasing Sᵣ₋ₒ₋ₜ, decreasing T_{speed}, and/or decreasing P_{force}. Spindle torque can be increased by decreasing Sᵣ₋ₒ₋ₜ, increasing T_{speed}, and/or increasing P_{force}.

Other modulation schemes can be used. For instance, modulation of the Sᵣ₋ₒ₋ₜ, the T_{speed}, and/or the P_{force} can include increasing and/or decreasing the Sᵣ₋ₒ₋ₜ, the T_{speed}, and/or the P_{force} while holding one or more constant. Modulation of the Sᵣ₋ₒ₋ₜ, the T_{speed}, and/or the P_{force} can include increasing and/or decreasing the Sᵣ₋ₒ₋ₜ, the T_{speed}, and/or the P_{force} while allowing one or more to be uncontrolled. Modulation of the Sᵣ₋ₒ₋ₜ, the T_{speed}, and/or the P_{force} can include increasing and/or decreasing any number of the Sᵣ₋ₒ₋ₜ, the T_{speed}, and/or the P_{force} simultaneously.

Modulation of the Sᵣ₋ₒ₋ₜ, the T_{speed}, and/or the P_{force} can include increasing and/or decreasing any number of the Sᵣ₋ₒ₋ₜ, the T_{speed}, and/or the P_{force} in a successive order. Modulation of the Sᵣ₋ₒ₋ₜ, the T_{speed}, and/or the P_{force} can include increasing and/or decreasing the Sᵣ₋ₒ₋ₜ, the T_{speed}, and/or the P_{force} as a primary modulation and one or more as a secondary modulation (e.g., the primary parameters are modulated before the secondary parameters, etc.). Modulation of the Sᵣ₋ₒ₋ₜ, the T_{speed}, and/or the P_{force} can include increasing and/or decreasing the Sᵣ₋ₒ₋ₜ, the T_{speed}, and/or the P_{force} as a gross modulation and one or more as a fine tune modulation. Modulation of the Sᵣ₋ₒ₋ₜ, the T_{speed}, and/or the P_{force} can include increasing and/or decreasing the Sᵣ₋ₒ₋ₜ, the T_{speed}, and/or the P_{force} within a set modulation range. Modulation of the Sᵣ₋ₒ₋ₜ, the T_{speed}, and/or the P_{force} can include increasing and/or decreasing the Sᵣ₋ₒ₋ₜ, the T_{speed}, and/or the P_{force} as a function of another.

The control module 126 can be configured to receive the spindle torque signal and generate the command signal and/or the recommendation signal in a feedback loop, thereby provide feedback loop control of the FSW unit 102. The feedback loop can be a closed control feedback control scheme, an open loop feedback control scheme, continuous control, discrete control, etc.

In some embodiments, the sensor module 124 can be configured to detect an in-plane force acting upon the welding tool 106 when the welding tool 106 is caused to perform work on a workpiece 104. The in-plane force can be defined as a force essentially normal to the spindle axis 118. Upon detecting the in-plane force, the sensor module 124 can generate an in-plane force signal representative of the in-plane force. The control module 126 can be configured to receive the in-plane force signal and generate a command signal and/or a recommendation signal to modulate the T_{speed} in response to the in-plane force signal. This modulation can be used in lieu of the modulation discussed above regarding spindle torque, used in combination therewith, used to augment the modulation based on the spindle torque values, etc. For instance, the control module 126 can be configured to set one or more limits on the T_{speed} or modulation of the T_{speed} based on the detected in-plane force. For instance, the control module 126 can modulate the parameters based on the spindle torque but also set a limit on the T_{speed} or modulation of the T_{speed} based on the detected in-plane force. This can be done to prevent damage to the welding tool 106 and/or prevent defects in the workpiece 104.

As can be appreciated from the above, spindle torque is not the only force that can be monitored and used as a means to modulate operation of the FSW unit 102. As noted above, in-plane forces. As described below, other forces, pressures, etc. can be also used.

An exemplary embodiment of the friction stir welding apparatus 100 can include a FSW unit 102 configured to rotate a welding tool 106 about a spindle axis 118 at a spindle rate of rotation (Sᵣ₋ₒ₋ₜ), cause the welding tool 106 to travel in a direction perpendicular to the spindle axis at a travel speed (T_{speed}), and/or cause the welding tool 106 to impart a downward force on a workpiece 104 at a plunge force (P_{force}). The FSW apparatus 100 can include a sensor module 124 configured to detect a spindle torque and generate a spindle torque signal representative of the spindle torque. The FSW apparatus 100 can include a control module 126 configured to receive the spindle torque signal and generate a command signal and/or a recommendation signal to modulate the P_{force} in response to the detected spindle torque. The control module 126 can be configured to generate the command signal and/or the recommendation signal to modulate the P_{force} so that one or more of the following is held at a constant value: a) an excess shoulder pressure; b) a measurement parameter that is proportional to P_{force}; c) a measurement parameter that is proportional to spindle torque; and/or d) a measurement parameter that is proportional to a dimension of the welding tool. The excess shoulder pressure can be achieved by maintaining a shoulder pressure at a fixed value greater than flow stress. The excess shoulder pressure=(P_{force}/shoulder area)−flow stress. The shoulder area is an area of a shoulder 116 of the welding tool 106. Flow stress is a measure of an average contact shear stress at an interface between the welding tool 106 and the workpiece 104, calculated from the welding tool 106 geometry and the measured spindle torque signal.

An exemplary embodiment of the friction stir welding apparatus 100 can include a FSW unit 102 configured to rotate a welding tool 106 about a spindle axis 118 at a spindle rate of rotation (Sᵣ₋ₒ₋ₜ), cause the welding tool 106 to travel in a direction perpendicular to the spindle axis 118 at a travel speed (T_{speed}), and/or cause the welding tool 106 to impart a downward force on a workpiece 104 at a plunge force (P_{force}). The FSW apparatus 100 can include a sensor module 124 configured to detect: a) a spindle torque and generate a spindle torque signal representative of the spindle torque; b) an in-plane force and generate an in-plane signal representative of the in-plane force; and/or a P_{force}, used to calculate an excess shoulder pressure and generate an excess shoulder pressure signal representative of the excess shoulder pressure. The FSW apparatus 100 can include a control module 126 configured to receive the spindle torque signal, the in-plane force signal, and/or the excess shoulder pressure signal. The control module 126 can be configured to generate a command signal and/or recommendation signal to modulate the Sᵣ₋ₒ₋ₜ, the T_{speed}, and/or the P_{force} in response to the detected spindle torque, the detected in-plane force, and/or the detected excess shoulder pressure. The control module 126 can be configured to generate the command signal and/or the recommendation signal to modulate the Sᵣ₋ₒ₋ₜ, the T_{speed}, and/or the P_{force} so that: a) the detected spindle torque stays within a range of spindle torque values; and/or b) the detected in-plane force stays within a range of in-plane force values.

The control module 126 can be configured to receive the spindle torque signal, the in-plane force signal, and/or the excess shoulder pressure signal, and generate the command signal in a feedback loop. In addition, or in the alternative, the control module 126 can be configured to receive the spindle torque signal, the in-plane force signal, and/or the excess shoulder pressure signal, and generate the recommendation signal in a feedback loop.

The control module 126 can be configured to hold the Sᵣ₋ₒ₋ₜ, the T_{speed}, and/or the P_{force} constant while modulating one or more of the Sᵣ₋ₒ₋ₜ, the T_{speed}, and the P_{force}. The control module 126 can be configured to increase the T_{speed} to generate a predetermined in-plane force, modulate the Sᵣ₋ₒ₋ₜ and/or the P_{force} while holding the T_{speed} at a value that maintains the predetermined in-plane force. The predetermined in-plane force can be a maximum in-plane force that will not damage the welding tool 106, will not result in premature failure of the welding tool 106, achieve optimum weld productivity (e.g., maximize T_{speed}−increasing T_{speed} until an in-plane force setpoint is reached, thereby maximizing weld productivity), etc.

An exemplary embodiment can relate to a method for controlling a friction stir weld. The method can involve initiating spindle speed, travel speed, and plunge force for a welding tool 106 that is engaged with a workpiece 104. The method can involve controlling flow stress experienced at an interface between the welding tool 106 and the workpiece 104. This can be achieved by: a) modulating spindle speed only; b) modulating spindle speed and travel speed, each being modulated within predefine operating limits, and each being modulated independently of the other; c) modulating spindle speed and travel speed, each being modulated within predefine operating limits, and modulation of one is dependent on modulation of the other by imposing a relationship between spindle speed modulation and travel speed modulation; and/or d) manipulating plunge axis position to modulate plunge force.

Controlling flow stress can involve modulating spindle speed, travel speed, and/or plunge force to maintain a constant spindle torque.

The method can further involve maintaining a constant workpiece 104 temperature at the interface between the welding tool 106 and the workpiece 104 can be achieved by maintaining the constant spindle torque.

### EXAMPLES

The following disclosure discusses exemplary implementations of control techniques and test data related to the same.

### Example 1

As can be appreciated from the above disclosure, the inventor recognized that the observed spindle torque results from the summation of the average contact shear stress between the tool and the workpiece, which is itself the net result of the average workpiece temperature at the interface. As a result, the benefits of closed-loop temperature control can be realized more easily by closed-loop control of the spindle torque, which can eliminate the need for measuring the tool or workpiece temperature and possibly improving the response time.

Techniques disclosed herein relate to a method of controlling the FSW process to hold a fixed spindle torque or calculated workpiece flow stress. The flow stress can be an alternate way of expressing the spindle torque that also includes aspects of the welding tool geometry. This approach can facilitate generalizing the control algorithm with respect to workpiece thickness and welding tool design. However, it is the spindle torque that is ultimately the parameter that the controller maintains in practice. If the controller is designed to maintain a constant flow stress, this flow stress setpoint can be internally converted to spindle torque for the purpose of control, using the specified welding tool geometry parameters in the conversion.

Welding research has shown that defects in friction stir welds can be produced when the material surrounding the welding tool is excessively hot and soft, producing low values of spindle torque. To use torque or flow stress control to avoid these defects, it is beneficial to find the torque or flow stress threshold, below which defects are produced. To do this, a series of progressively hotter welds, with progressively decreasing spindle torque, can be performed in a particular workpiece material while monitoring the torque, making note of the torque level at which defects appear. Once the threshold torque is known for a particular welding tool in a particular workpiece material, welds can be controlled to maintain a torque that is higher than this threshold, ensuring weld quality, even when the boundary conditions change along the length of the weld. Alternatively, this threshold torque can be used, along with the welding tool geometry parameters, to calculate the threshold flow stress.

Defects can also form in friction stir welds when the machine settings result in the material surrounding the welding tool being excessively cold. An approach like the one outlined above can be used to determine the threshold torque or flow stress, above which defects are formed. The torque or flow stress control algorithm can then be used to stay below this threshold to avoid defects. By staying between the high and low torque threshold, weld quality can be ensured regarding heat input.

Various types of defects are possible. One notable type of defect is associated with proximity to the boundary between the stirred zone of material (SZ) and the thermo-mechanically affected zone (TMAZ), just outside of the SZ. This “SZ Boundary” defect is always associated with excessively high flow stress, implying low weld zone temperature. Another type of defect is associated with excessively high weld pitch, exceeding the “pitch capacity” of the welding tool design. A third defect type is associated with excessively low flow stress, suggesting that conditions at the tool/workpiece interface have exceeded the hot workability limits of the workpiece material. Other defect types are associated with errors in machine operation, welding tool design and workpiece fixturing.

Manipulation of the spindle torque during welding can be accomplished by changing three different machine settings. First, changing the plunge force can directly change the torque, such that increasing plunge force produces increasing torque, and vice versa. Second, changing the spindle speed can inversely change the torque, such that increasing the spindle speed decreases the torque. Third, changing the travel speed can directly change the torque, with increasing travel speed producing increasing torque.

Manipulation of spindle torque by making changes to the plunge force can itself produce defects. Contact between the shoulder of the welding tool and the workpiece surface is needed in order to effectively contain the softened workpiece material and prevent its escape from the weld zone. Also, reducing the plunge force necessarily involves retracting the welding tool from the workpiece, which increases the gap between the end of the welding tool pin and the anvil, which can produce a type of defect from lack of weld penetration below the tip of the pin. Therefore, using plunge force or plunge depth to control torque can only be effective within the limits that avoid these defects.

Flow stress or torque control can be accomplished by manipulation of the spindle speed and/or the travel speed during a weld. To do this, the weld controller is given a torque (or flow stress) setpoint of some value that is known to be above the threshold of “hot” defect production and below the threshold of “cold” defect production, for example. Once the weld is started, the weld controller can monitor the spindle torque and respond to changes in real time. If the torque increases from the desired setpoint, the controller can decrease the travel speed or increase the spindle speed to keep the torque at the setpoint. Conversely, if the torque decreases from the setpoint, the controller can increase the travel speed or decrease the spindle speed to keep the torque or flow stress at the setpoint. The way that these machine settings are changed is the subject of the control algorithm.

There are different ways that the torque or flow stress control algorithm can be implemented. An exemplary, simple form can be to use either spindle speed or travel speed alone to manipulate the spindle torque to hold it constant while external conditions are changing. However, in cases where there are extreme changes in boundary conditions it may be beneficial to manipulate both variables, keeping spindle speed within a specific range and using travel speed to produce additional influence, as needed, for example. Also, other objectives can be controlled by the algorithm, such as maximizing productivity or tool life. Below are some exemplary variations of the control algorithm that can be used:
1. Spindle speed alone: in this approach, the spindle speed is the only manipulated variable. If the torque increases, simply increase the spindle speed to hold the torque constant. If the torque decreases, decrease the spindle speed to maintain constant torque.
2. Travel speed alone: If the torque increases, decrease the travel speed. If the torque decreases, increase the travel speed.
3. Spindle speed within limits, then travel speed: In this approach, the controller uses spindle speed as the primary control variable, within limits, then uses travel speed as needed when the spindle speed limitation is reached.
4. Travel speed within limits, then spindle speed: In this approach, the controller uses travel speed as the primary control variable within specified limits, then uses spindle speed as needed.
5. Spindle speed and travel speed within limits, maximizing productivity without degrading tool longevity: This approach maintains maximum travel speed while keeping the torque or flow stress at the desired setpoint. An additional limitation on the in-plane force is specified for the welding tool being used to prevent premature tool failure due to overloading. When initiated, the controller will progressively increase the travel speed and manipulate the spindle speed to maintain constant torque or flow stress. The travel speed will be limited once the in-plane force setpoint is reached. If the spindle speed reaches its limitation and torque is still off the setpoint, the travel speed will be increased or reduced as needed to maintain constant torque or flow stress. This approach prioritizes spindle speed for control of torque or flow stress and prioritizes travel speed for maximum productivity within the strength limits of the welding tool.
6. Three-dimensional control, holding flow stress, maximizing productivity, avoidance of tool longevity degradation and elimination of excess flash production: The welding control algorithm can manipulate the plunge force, travel speed and spindle speed simultaneously to maintain the torque or flow stress setpoint while maximizing productivity and reducing or eliminating the production of excess flash. In practice, each machine setting would be prioritized for different effects. A flash monitor function is added here to detect the formation of flash and manipulate the plunge force or plunge position, within limits, to eliminate flash. At the same time, spindle speed and travel speed are manipulated to hold the torque or flow stress setpoint while maximizing productivity, as described above. The flash monitor function can be in the form of an added sensor or camera with appropriate software, or in can be purely based on calculation of flow stress and energy density, as has been demonstrated in experiments.

There are practical benefits to the use of torque or flow stress control, some of which are listed below:
1. Maintenance of more consistent welding conditions along the length of a weld, regardless of changes in boundary conditions.
2. Elimination of the need to install thermocouple(s) (or other temperature-measurement devices) and transmit temperature data to the machine controller.
3. Maximizing welding speed while avoiding premature tool failure, while maintaining weld quality and avoiding the production of excess flash, while maintaining forcible shoulder contact without producing weld lack of penetration.

### Exemplary Reduction to Practice

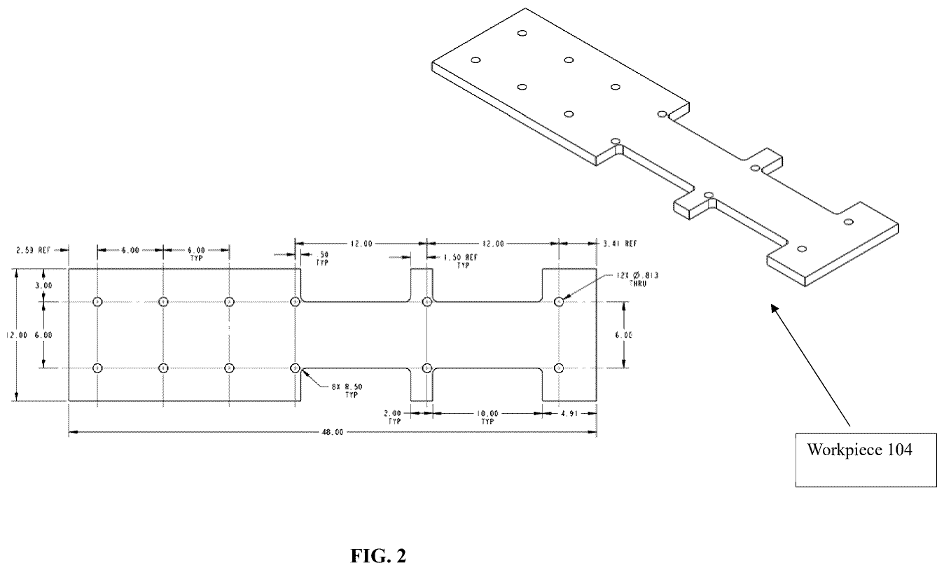

To demonstrate use of torque as a control setpoint, a series of welds were made in 1-in thick 7075-T6 aluminum plates with variable geometry, referred to as “fishbone” weld panels, shown schematically for example, in FIG. 2. Welds were made using only travel speed manipulation, only spindle speed manipulation, and using both spindle speed and travel speed manipulation, maintaining a constant spindle torque setpoint. The commands to change spindle speed or travel speed were manually executed. The welding engineer monitored the current spindle torque, displayed on the welding machine user interface, and called out speed and/or feed rate changes to the operator. Welds were made in 6-in, 5-in, 4-in and 3-in reduced width fishbone panels. In the 3-in panels, welds were made by manipulating both spindle speed and travel speed to hold constant flow stress while limiting the in-plane force on the welding tool.

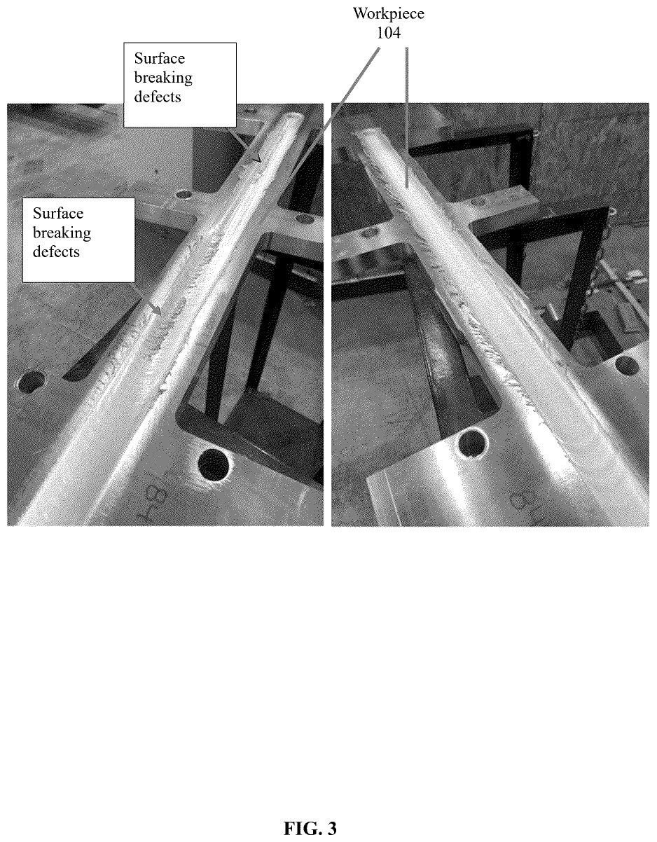

Photos from two representative welds are shown in FIG. 3. The weld on the left in the photo was made with the machine operator manipulating the plunge force/position to maintain constant shoulder contact with the plate surface, which is commonly the only form of control available. While the shoulder contact was successfully maintained, surface-breaking defects were produced in the reduced width sections, due to the restriction in the boundary conditions which produced excessively hot welding conditions. In the weld shown on the right in the figure, spindle speed and travel speed were both manipulated to maintain constant spindle torque with constant plunge force, resulting in no internal defects and no “excessive” flash production. The ability to make this weld without changing the plunge force is an important achievement, demonstrating the constancy of welding conditions while boundary conditions change. The present invention simply automates the manual process used in these welds.

### Example 2

The present study developed analytical techniques for analysis of welds from various thickness and welding tool designs by expressing the variables of interest in terms of unit area of welding tool surface. Previously, a method of expressing the spindle torque on a unit-area basis resulted in a calculation of the average flow stress in the workpiece at the tool/workpiece interface. This approach was extended here to the calculation of average heat flux and average energy density, which express aspects of welding tool geometry, workpiece thickness, travel speed, spindle speed and observed spindle torque. Additionally, the forge force and resultant in-plane lateral forces on the welding tool are analyzed in terms of tool surface area to yield shoulder pressure and lateral probe pressure. These unit-area quantities are analyzed in this ongoing study with reference to machine settings, excess flash production, macro-section characteristics, defect formation and tensile strength in FSW of aluminum alloys. In welding experiments conducted in 25-mm and 50-mm 7075 aluminum plate, it was observed that the flow stress response surface with respect to volumetric flowrate and the inverse of the surface velocity forms a plane for each thickness of workpiece, implying that the flow stress response surface is possibly planar, but of different magnitude and slope, for other constant thermal boundary conditions. This was confirmed by analysis of the FSW Data Set published earlier. It was also found that in a series of welds made with decreasing flow stress, below a threshold of about 24 MPa, weld defects were produced. This same threshold was observed in 25 mm and 50 mm 7075-T6 welds, implying that this threshold may be universal for a given alloy. To test the practical utility of this observation, welds were made in 25 mm 7075 in plates with variable width while using manual changes to travel speed and spindle speed to maintain a constant value of flow stress in the weld. The results suggest that a welding controller that manipulates spindle speed and travel speed to produce a constant flow stress that is well above the identified threshold could produce defect-free welds despite changing boundary conditions, such as changing joint geometry.

### Introduction

Friction stir welding procedures are defined by several basic variables which describe the welding tool and workpiece geometry, the machine settings and a number of other details. Often, these parameters become part of the welding procedure specification that is qualified for production of a particular product. However, a greater understanding of the welding procedure can be gained by using the most basic variables to calculate more meaningful data features to represent aspects of the process. As a simple analogy, it is more meaningful to describe a container by its volume rather than by its diameter and length.

Although spindle speed, travel speed and spindle torque are known to have key roles in the generation and dissipation of heat, it is difficult to draw useful conclusions regarding welding procedures in general from these basic variables. One goal of unit-area analysis is to provide a means of normalizing FSW data to produce new data features that are more meaningful, with implications for welding specifications, machine control, quality assessment and other topics of interest in the field.

Another motivation for this work came from the recent emergence of machine learning as applied to manufacturing technologies. In this area it is helpful for training an algorithm to engineer data features that represent significant physical relationships in the field of study. To this end, the unit-area analysis described here was developed to normalize the data from diverse welding procedures and to produce data features with physical significance that could be used with a pattern recognition algorithm, for example, to aid in the prediction of outcomes from those procedures. Other derived quantities, not necessarily based on the area of the welding tool surface, are also meaningful with respect to machine learning.

Significant work has been done to relate the basic variables in FSW to more meaningful derived quantities, most notably with respect to heat generation and dissipation. Researchers have developed various approaches to expressing heat generation in FSW, often as input to models for predicting temperature distribution during welding. The earliest approaches represented the heat as coming from the shoulder only, assuming a circular heat source on the plate surface to calculate heat input from an assumed friction coefficient or based on the workpiece shear flow stress, acting on the shoulder area. Analysis of the contact conditions between the tool and matrix followed, leading to the conclusion that heat generation could be best represented as being based on the shear flow stress acting on all tool surfaces in contact with the workpiece. In 2002, an important analytical step was made by relating the spindle torque to the shear flow stress of the matrix, assuming a uniform average shear flow stress distributed over the tool surfaces. A detailed analysis was developed which concluded that in FSW, the contact conditions in FSW of aluminum generate plastic deformation over most of the tool surfaces, except for a small region at the periphery of the shoulder, where frictional heating generates very close to the same heat as the sticking condition. Based on these analyses, it was concluded that the spindle torque can be represented as the summation of an average contact shear stress distributed over the tool/workpiece interface. This is presented here in terms of an average normal stress in the workpiece.

In this work, unit-area analysis was examined with respect to its implications for machine control. Various methods of closed-loop control of friction stir welds have been demonstrated. Methods have broadly been based on force and temperature. Force-based methods, employed since the very beginning of FSW research, focused primarily on the axial force component as a means of controlling welding tool depth to maintain constant welding conditions with variable workpiece alignment relative to the elevation of the welding head, or to compensate for welding machines that have variable stiffness over the envelope, such as for robotic systems or for systems with a very large envelope. Temperature-based control has been shown to be very successful in maintaining constant welding conditions in the face of variable weld boundary conditions by using thermocouples embedded in the rotating welding tool to measure the tool temperature very near the tool/workpiece interface. With previous control techniques, torque control was employed with the goal of ensuring constant shoulder engagement with the workpiece surface. This is in contrast to the methods described here.

### Unit-Area Analysis

Unit-area analysis seeks to combine welding tool geometry, machine settings and measured forces to form derived quantities that are more meaningful to characterization of welding conditions than the constituent basic variables. The important variables in this formulation are summarized in Table 1. Note that some of the derived quantities are not strictly “per unit area” but are nonetheless key aspects of the analysis.

TABLE 1
Summary of derived quantities.
Process Inputs

| | |
|---|---|
| G Parameter (average), mm\hat{ }3 | Average (radius × area) of tool surface |
| Surface Velocity (average), | Area-based average tool surface |
| m/s | velocity |
| Volumetric Flowrate, mm\hat{ }3/s | Volume of workpiece material swept by |
| | the tool profile per unit time |

Process Outputs

| | |
|---|---|
| Flow Stress (average), MPa | Resistance to tool rotation per unit |
| | tool area |
| Shoulder Pressure, MPa | Axial pressure based on shoulder outer |
| | diameter |
| Lateral Probe Pressure, MPa | In-plane force resultant divided by |
| | probe profile area |
| Heat Flux, W/mm² | Power output per unit tool area |
| Energy Density, J/mm³ | Energy input per unit volume of material |
| | swept by the tool |

### Parameter G

Parameter G, sometimes referred to as “geo”, refers to a mathematical summation of the incremental areas of the tool surface multiplied by their radii. The term is useful in unit-area analysis for the calculation of flow stress and surface velocity, and it captures the essential welding tool geometry for this use. G is defined as:

$$G = {\int }_{S} r dA \qquad ( 1 )$$

The solutions for (1) depend on the form of the welding tool. For a concave or flat shoulder, a frustrum or cylindrical probe and a flat probe tip,

$$G = \frac{2 π}{3} [ \frac{{S}^{3} - {P}_{r}^{3}}{cos α} + \frac{t ( {( {P}_{R} + {P}_{T} )}^{2} - {P}_{R} {P}_{T}}{cos β} + {P}_{T}^{3} ] , ( units : {length}^{3} ) \qquad ( 2 )$$

where,
α=shoulder taper angle
β=frustum probe half angle
S=shoulder radius
P_{R}=probe root radius
P_{T}=probe tip radius
t=workpiece thickness, or probe length

Complete equations for flat, tapered and convex shoulders and frustum or cylindrical probes are given in the Data Set Topic document, available for download with the FSW Data Set.

### Surface Velocity

An area-based surface velocity was derived previously. In the past, researchers have attempted to normalize spindle speed to account for differences in tool size by simply expressing the maximum surface velocity at the periphery of the shoulder or at the surface of a cylindrical probe. The present approach mathematically sums the surface velocity of each incremental area of the tool as,

$$Average surface velocity = ω \overline{r} = \frac{ω {\int }_{S} r dA}{total surface area} \qquad ( 3 )$$

The surface integral in the numerator is equal to G, from equations (1) and (2), resulting in,

$$ω \overline{r} = ω [ \frac{\frac{2}{3} [ \frac{{S}^{3} - {P}_{R}^{3}}{cos α} + \frac{t ( {( {P}_{R} + {P}_{T} )}^{2} - {P}_{R} {P}_{T} )}{cos β} + {P}_{T}^{3} ]}{\frac{( S + {P}_{R} ) ( S - {P}_{R} )}{cos α} + \frac{t ( {P}_{R} + {P}_{T} )}{cos β} + {P}_{T}^{2}} ] , \qquad ( 4 )$$

$$( units : length per unit time )$$

Again, complete equations for various tool styles are given in the Data Set Topics document.

### Volumetric Flowrate

Volumetric flowrate is simply a measure of the volume of material swept by the welding tool per unit time and is calculated as the travel speed multiplied by the profile area of the probe, with units of cubic length per unit time. The calculation of weld pitch was an early attempt at normalizing the travel speed, expressed as the travel speed divided by the spindle speed.

However, this form confounded travel speed with spindle speed and did not account for differences in workpiece thickness. Another version of this normalization expressed weld pitch in terms of travel distance per revolution per feature, in attempt to mimic the “chip load” calculation that is common in machining literature, although this form did not yield significant insight into process.

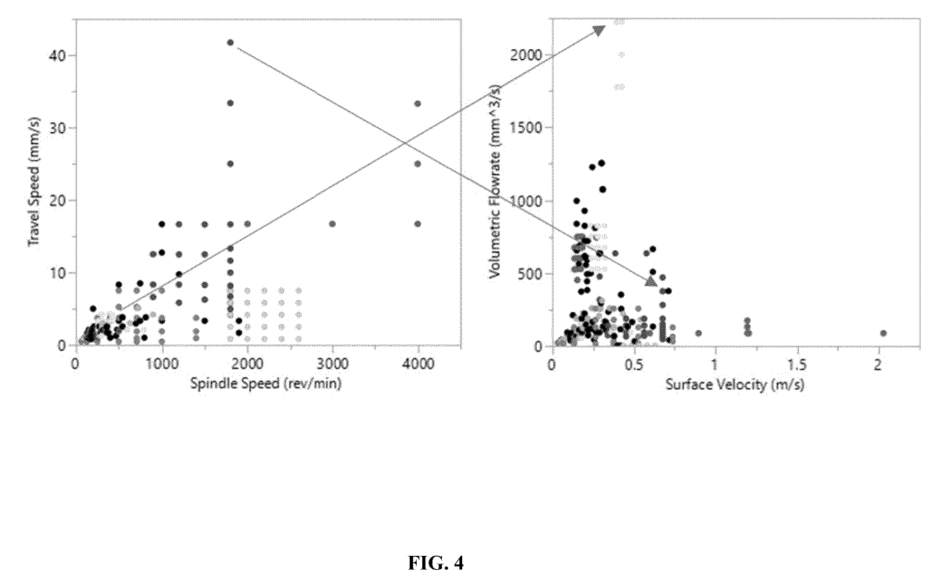

FIG. 4 demonstrates the utility of analyzing the current Data Set procedures in terms of surface velocity and volumetric flowrate. What appears to be a high travel speed, on the left of the figure, is viewed much differently in terms of volumetric flowrate. Similarly, what appears to be a low spindle speed can represent a more moderate surface velocity, depending on the size of the tool. Normalizing the data in this way offers a more rational context to compare conditions from diverse welding procedures.

### Flow Stress

Much like the component forces and measured temperature at the tool/workpiece interface, the spindle torque reflects conditions present during welding in real time. However, taken in its most basic form, the significance of the torque produced in a particular weld is difficult to appreciate. It is by using the torque and the welding tool geometry to calculate average flow stress that it becomes possible to grasp meaningful trends in the data.

Following the detailed analysis by others, a control surface that mirrors the general profile of the welding tool, just outside of the threads and other features of the tool, experiences plastic deformation at practically all points. The contact shear stress on this surface is therefore equal to the shear flow stress in the workpiece. To calculate normal flow stress, the average shear yield stress is first calculated by dividing the measured spindle torque by the surface integral of the radius,

$${τ}_{yield} = \frac{T}{{\int }_{S} r dA} = \frac{T}{G} \qquad ( 5 )$$

where T is the spindle torque and S is the total surface of the tool, including the shoulder, the probe sides and the probe end. For a flat or tapered shoulder and a frustum or cylindrical probe,

$${τ}_{yield} = \frac{T}{\frac{2 π}{3} [ \frac{{S}^{3} - {P}_{r}^{3}}{cos α} + \frac{t ( {( {P}_{R} + {P}_{T} )}^{2} - {P}_{R} {P}_{T} )}{cos β} + {P}_{T}^{3} ]} \qquad ( 6 )$$

The normal flow stress is calculated from the shear flow stress using the von Mises yield criterion,

$${σ}_{yield} = {τ}_{yield} \sqrt{3} ( units : force per unit area ) \qquad ( 7 )$$

It should be noted that this calculation simply reflects an average distribution of the torque over the surfaces of the welding tool, as if the distribution was uniform. It is certain that this does not reflect reality. It is known, for example, that there are parts of the welding tool that are not in contact with the workpiece at all, based on experimental evidence. Further, it is likely that the local flow stress and local temperature at a given point is dependent on the local surface velocity, so it should be clear that the average flow stress is not representative of local conditions at a point on the tool surface. For the purposes of this study, it does not appear necessary to have such a detailed understanding of local conditions, but a clear understanding of the nature of the average flow stress is needed to accurately interpret some results.

### Shoulder Pressure and Lateral Probe Pressure

These derived quantities are simply a way to normalize the plunge and in-plane forces with respect to tool geometry. Shoulder pressure is calculated as,

$$SP = \frac{{F}_{plunge}}{π {S}^{2}} ( units : force per unit area ) \qquad ( 8 )$$

The lateral probe pressure, for a frustum or cylindrical probe, is calculated as,

$$LP = \frac{\sqrt{( {F}_{longitudinal}^{2} + {F}_{transverse}^{2} )}}{t * ( {P}_{r} + {P}_{t} )} , ( units : force per unit area ) \qquad ( 9 )$$

### Heat Flux

The heat flux represents the power output per unit tool area and is calculated from the shear flow stress (Eqn. (5)) and the average surface velocity, from Eqn. (4), as:

$${ϕ}_{q} = {τ}_{yield} \times ω \overline{r} ( units : power per unit area ) \qquad ( 10 )$$

### Energy Density

Early research in FSW attempted to normalize heat input based on the power output and the travel speed, yielding calculation of “specific energy” [Error! Reference source not found.]. However, this formulation did not account for the differences possible with respect to workpiece thickness. To improve the expression of the energy put into the workpiece, in terms of volume of processed material, the energy density is calculated from the heat flux as,

$${ρ}_{E} = \frac{{ϕ}_{q}}{travel\_speed} ( units : energy per unit volume ) \qquad ( 11 )$$

### Data Set Analysis

Data was collected from published and unpublished sources for inclusion in a publicly available data (“Data Set”). This data set has been greatly expanded from the original release by expanding the number of data fields to include greater detail in procedure definition, in recording outcomes and in derived quantities. The data set is no longer restricted to welds of good quality, and much of the data set expansion is related to recording various measures of weld quality. The data set is also no longer restricted to aluminum alloys, with the hope that many more procedures can be recorded for other metals. A Data Set Topics document has been added to the download, to document requirements for each data field and to include documentation of all the equations used in the Derived Quantities section of the Data Set.

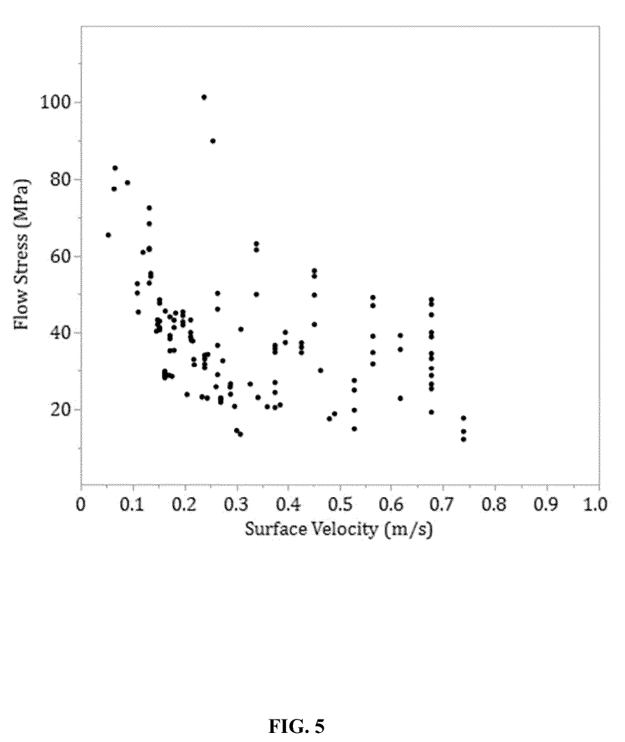

The data from the Data Set was analyzed with respect to flow stress as a function of surface velocity, excluding procedures that either had no quality information or were reported to have some quality “demerit”, as defined in the Data Set Topics, shown in FIG. 5. It is notable that there are relatively few procedures that report flow stress values below about 20 MPa and with surface velocity values below about 0.1 m/s. Considering that only procedures that were reported to have good quality were included, it was speculated that welds below 20 MPa and below 0.1 m/s surface velocity possibly tended to have defects.

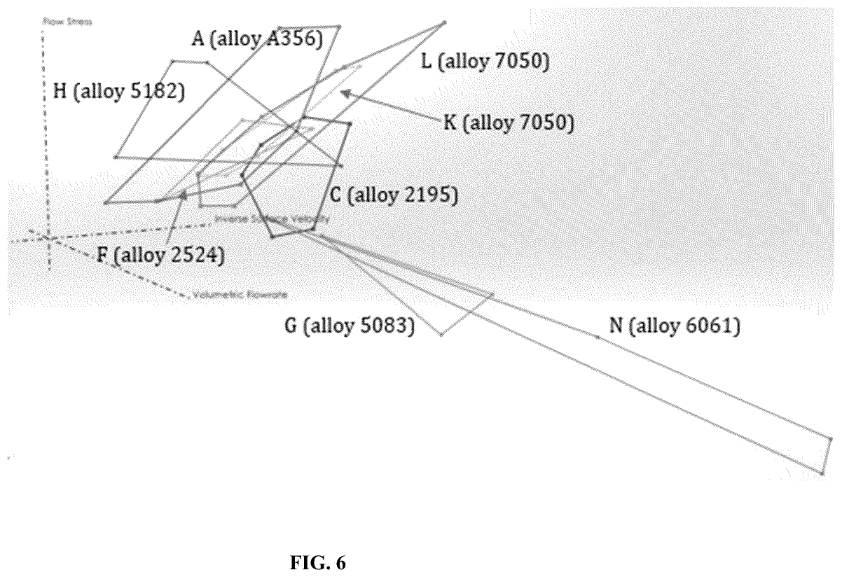

Analysis of the Data Set with respect to flow stress as a function of inverse surface velocity and volumetric flowrate showed that the data for individual cohorts of procedures tended to form linear response surface planes. FIG. 6 graphically summarizes the results of multiple regression analyses from each of the major cohorts in the Data Set, with key statistics listed in Table 2. In the figure, the borders represent the approximate limits of the data reported for each cohort.

TABLE 2
Summary of multiple regression analysis of flow stress
response with respect to inverse surface velocity
and volumetric flowrate by Data Set cohort.

| | Inverse | | | | |
|---|---|---|---|---|---|
| | Surface | Volumetric | | | |
| | Velocity | Flowrate | | | Standard |
| Cohort | Coefficient | Coefficient | Intercept | | Error |
| (Alloy) | (MPa/(m/s)) | (MPa/(mm\hat{ }3/s)) | (MPa) | R\hat{ }2 | (MPa) |
| A (A356) | 8.072 | 0.077 | −0.82 | 0.97 | 3.47 |
| C (2195) | 7.887 | 0.047 | −17.72 | 0.94 | 2.10 |
| F (2524) | 6.307 | 0.051 | −0.88 | 0.98 | 1.80 |
| G (5083) | 6.566 | 0.014 | −6.07 | 0.95 | 1.12 |
| H (5182) | 19.996 | 0.066 | −4.77 | 0.86 | 4.48 |
| K (7050) | 4.920 | 0.080 | 1.28 | 0.94 | 2.78 |
| L (7050) | 4.007 | 0.015 | 11.34 | 0.88 | 4.50 |
| N (6061) | 10.500 | −0.012 | −5.95 | 0.93 | 1.48 |

### Welding Experiments

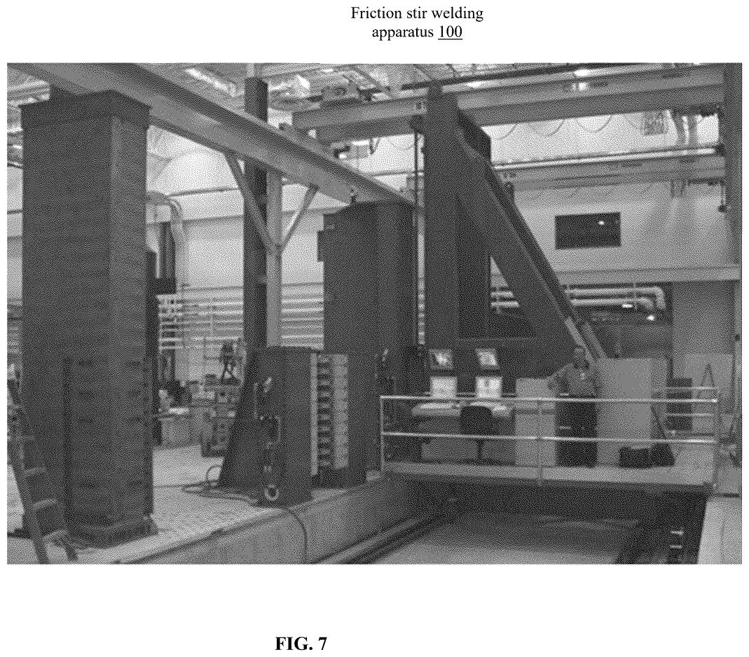

Unit-area analysis was applied to a series of welds made in nominally 25-mm and 50-mm 7050-T6 aluminum plates. Typical test plates measured 150 mm by 1,200 mm. All welds made were full penetration, bead-on-plate. The welding tool for the 25-mm welds had a 35.6-mm shoulder diameter that was flat and had three spiraled scrolls. The probes were frustum-shaped with threads with a 1.81-mm/thread pitch and had 5 flats, with a root diameter of 21 mm and a tip diameter of 12.7 mm. The two-piece tools had the probe length adjusted to about 0.5 mm less than the minimum plate thickness for each weld. The tools for the 50-mm welds had a flat, scrolled shoulder with a diameter of 47 mm. The probes were frustum-shaped with a 1.81-mm thread pitch and 5 flats, with a root diameter of 24 mm and a tip diameter of 11.8 mm, similarly adjusted for each weld with a length that was 0.5 mm less than the minimum plate thickness. All welds were made with 0° tool tilt. The welding system used was a FSW-H25K-5AX system, manufactured in 2000 by Mid-Columbia Engineering, shown in FIG. 7.

A series of welds was made to collect force and torque data as a function of spindle speed and travel speed. Welds were made in load control, attempting to maintain a constant plunge force with all speed/feed settings. However, some adjustments were necessary due to the broad range of settings explored. Duplicate welds were made in position control using a laser displacement sensor to reference the plate surface. To maximize the number of conditions that could be evaluated, each weld had multiple segments of different machine settings. A total of 49 unique speed/feed pairs were run in both load and position control, with selected replicates.

Each weld was inspected using phased-array ultrasonic testing (PAUT), radiographic testing (RT), macro examination and tensile testing. Each weld also had samples of the excess flash produced removed and weighed, permitting reporting of the weight of flash per unit length of weld for each weld segment. The data from each weld was analyzed to extract average force and torque values for each segment. To do this, segments of stable inputs and outputs for each segment were selected and averaged. Derived quantities were calculated from each segment of data, including surface velocity, volumetric flowrate, flow stress, heat flux and energy density.

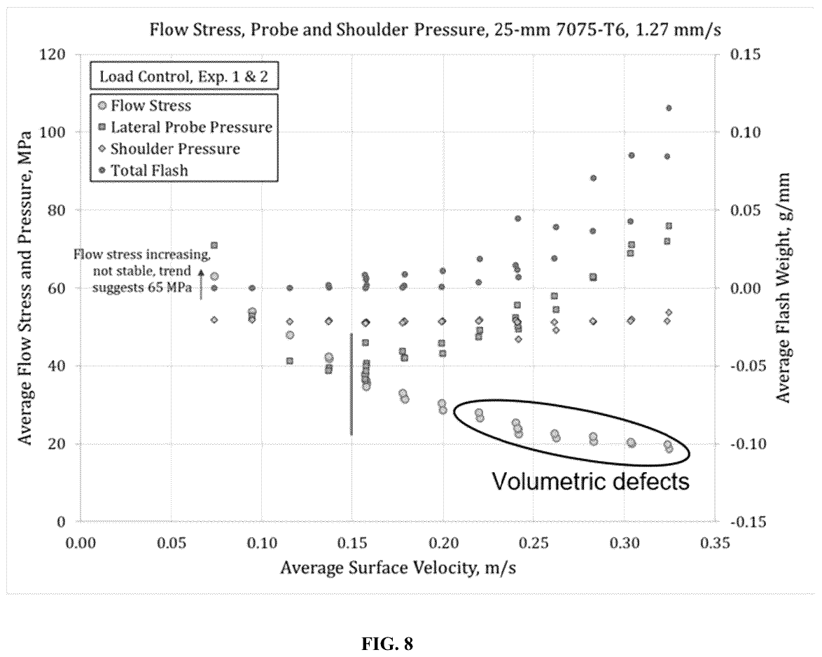

Selections from the full scope of testing and analysis are presented here to illustrate the unit-area analysis results. FIG. 8 shows flow stress, lateral probe pressure, shoulder pressure and total flash measurements for welds made at 1.27 mm/s travel speed and various spindle speeds ranging from 90 rev/min to 310 rev/min. These welds were made in load control with a shoulder pressure of about 51 MPa. The flash observed was zero below about 0.15 m/s surface velocity but above that value increased with increasing surface velocity. Below 0.15 m/s surface velocity, the flow stress and the lateral probe pressure were nearly equal and increased with decreasing surface velocity. These values diverged above 0.15 m/s surface velocity, with the flow stress continuing its previous trend while the lateral probe pressure increased continuously.

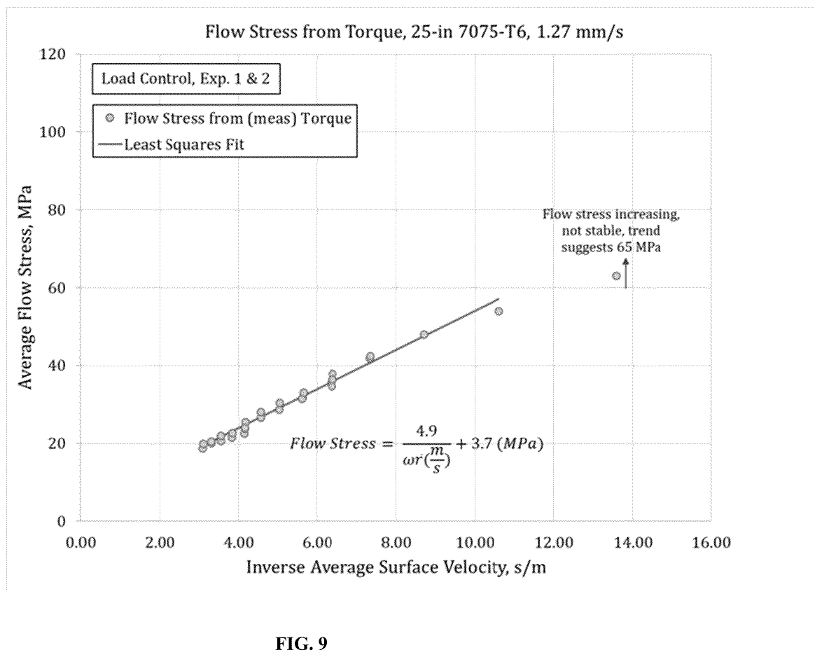

Study of the data from these experiments suggested that heat flux was generally linear with respect to travel speed. Using this as an assumption, it can be shown that if heat flux is linear with respect to travel speed, then flow stress must be linear with respect to the inverse of the surface velocity. When the flow stress data from FIG. 8 is plotted against the inverse surface velocity, the linear trend emerges, as shown in FIG. 9. The slope with respect to inverse surface velocity agrees favorably with results from Cohorts K and L in Table 2, which are from welds in 6.4-mm 7050 aluminum.

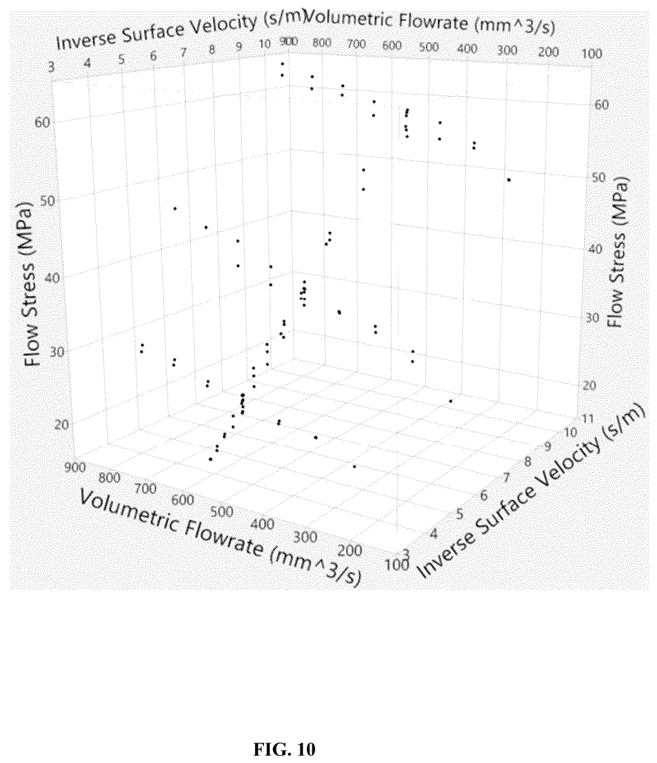

Multiple regression analysis was run on the 25-mm welds using inverse surface velocity and volumetric flowrate as independent variables. The regression results yielded the prediction expression below with a root mean squared error of 1.2 MPa and a R² value of 0.998, in good agreement with other results for this alloy in Table 2. The flow stress response surface is presented graphically in FIG. 10.

$${σ}_{yield} = \frac{4.85}{S V} + 0.0 \; 21 \times F R - 5.76 \qquad ( 12 )$$

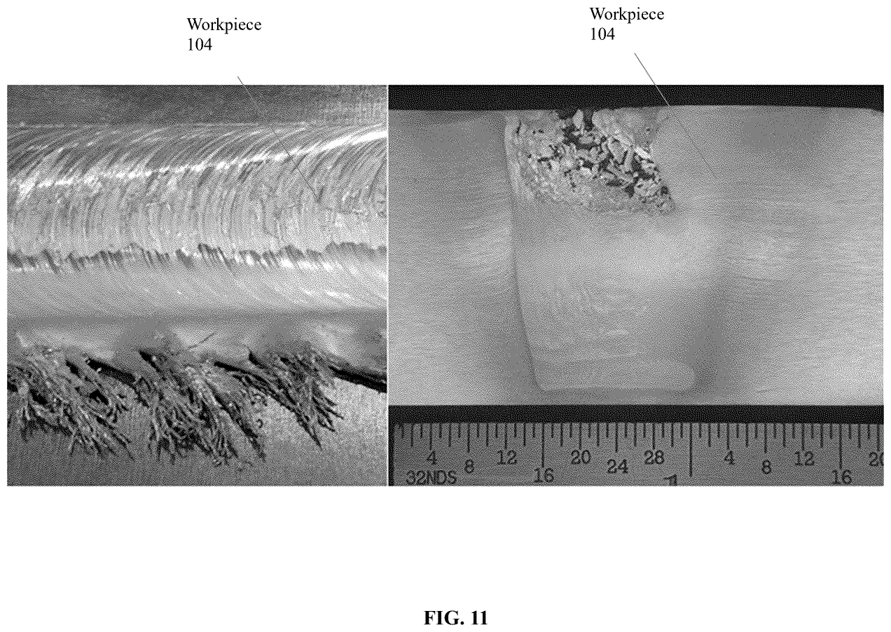

It was noted during analysis of the results that there seemed to be a correspondence between welds with low flow stress and volumetric defects, detected by visual inspection, PAUT, RT and macro-section examination. To further test this, a flow stress defect correlation experiment was made with four levels of flow stress using three different speed/feed combinations for each. The expression in Eqn. (12) was used to determine the machine settings that would yield the desired flow stress levels. Similar welds were made in 25-mm and 50-mm 7075-T6 plates. At the time of this writing, only visual inspection for surface tearing and excess flash were available to report. Surface tearing is a volumetric defect that is visible at the surface, an example of which is shown in the macro-section shown in FIG. 11. This defect has been reported elsewhere to coincide with excessive spindle speed but is seen here in the context of unit-area analysis to coincide with low flow stress.

A summary of the results from the flow stress defect correlation experiment is presented in Table 3. Surface tearing was observed when the flow stress was at or below 22.0 MPa, except in one case. Surface tearing was always accompanied by excess flash, although some weld segments had excess flash without surface tearing.

TABLE 2
Summary of flow stress defect correlation
experiment, 25 and 50-mm 7075-T6.

| Nominal | Flow | Surface | |
|---|---|---|---|
| Thickness (mm) | Stress (Mpa) | Tearing? | Flash |
| 25 | 25.8 | No | No |
| 25 | 25.8 | No | No |
| 25 | 25.5 | No | No |
| 50 | 24.8 | No | Yes |
| 25 | 24.1 | No | No |
| 25 | 23.8 | No | No |
| 25 | 23.6 | No | No |
| 50 | 23.3 | No | No |
| 50 | 22.9 | No | Yes |
| 25 | 22.9 | No | No |
| 25 | 22.7 | No | No |
| 50 | 22.4 | No | Yes |
| 50 | 22.2 | No | No |
| 25 | 22.0 | Yes | Yes |
| 50 | 21.7 | Yes | Yes |
| 25 | 20.9 | Yes | Yes |
| 25 | 20.4 | Yes | Yes |
| 25 | 20.3 | Yes | Yes |
| 50 | 18.9 | No | Yes |
| 50 | 17.9 | Yes | Yes |
| 50 | 17.9 | Yes | Yes |
| 50 | 17.8 | Yes | Yes |
| 50 | 17.6 | Yes | Yes |
| 50 | 17.5 | Yes | Yes |

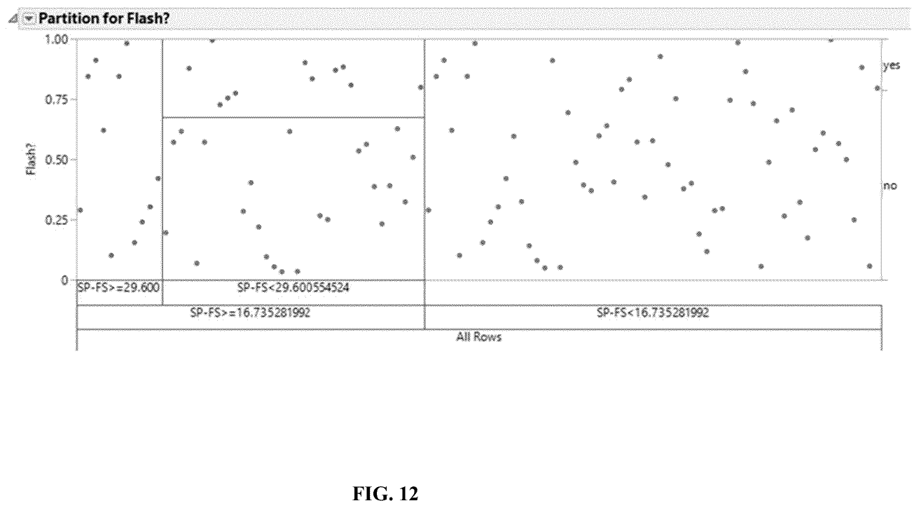

The production of excess flash was also examined. The flash observations from 25-mm 7075-T6 welds were analyzed in JMP statistical analysis software by building decision tree models based on various independent variables. The most predictive data feature was the difference between the shoulder pressure and the flow stress, SP-FS. As can be seen in FIG. 12, when SP-FS was below 16.7 MPa, no flash was produced and above 29.6 MPa, flash was always produced. The intermediate range showed mixed results.

The correlation between flow stress and weld quality was tested in a series of bead-on-plate welds that had variable geometry. Each panel was nominally 150 mm by 1,200 mm by 25 mm thick. The first half of each plate was full width, providing a section of weld where conditions could be stabilized. The second half of each plate had two regions with the width reduced to 150 mm, 127 mm, 102 mm or 76 mm. Preliminary testing showed that these reduced-width sections would exhibit reduced flow stress, possibly generating surface-tearing defects if attempted with constant, “normal” machine settings. Half of the panels were welded by manually modulating the spindle speed in steps to hold a constant spindle torque (constant flow stress). Half were welded by modulating the travel speed. In the most severe cases, with 76-mm width, both spindle speed and travel speed were modulated to hold constant torque.

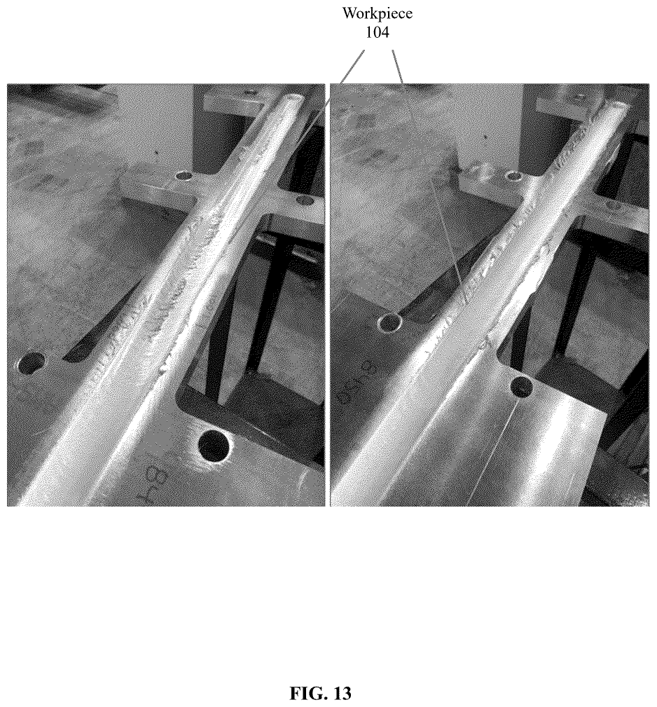

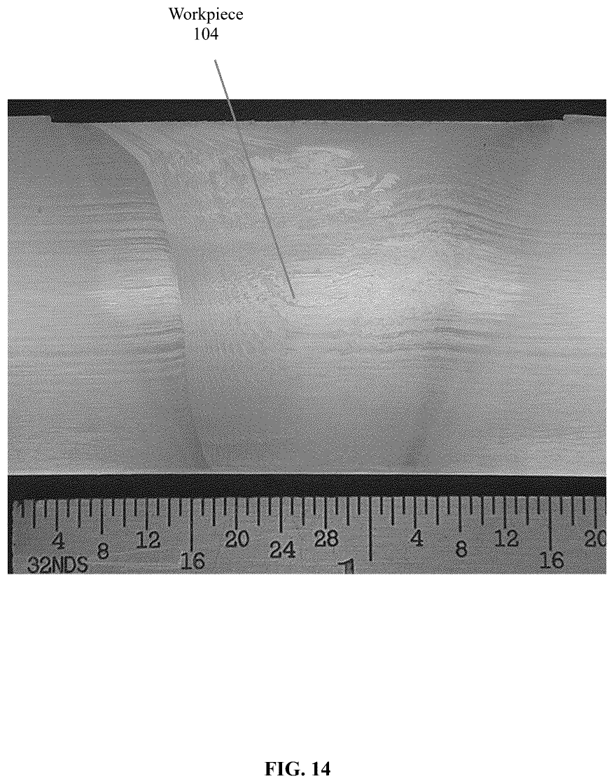

FIG. 13 shows plates with a 75-mm wide reduced width section that were welded in axial load control with and without flow stress control. In the weld on the left in the figure, the machine operators were instructed to navigate the weld by adjusting the plunge force to maintain uniform shoulder contact as the weld boundary conditions changed. Although they were successful in maintaining full shoulder contact with minimal flash, the surface-tearing defect commonly seen in welds with low flow stress appeared in each of the reduced-width sections. In the weld shown on the right in the figure, the flow stress was maintained at a constant 31 MPa by observing the spindle torque that was displayed in real time and adjusting both the travel speed and spindle speed to hold that torque setting. A constant shoulder pressure of about 45 MPa was maintained throughout. No defects were observed, although additional non-destructive and destructive testing is underway at this time. A similar weld, made in a panel with 100-mm width under flow stress control, exhibited no volumetric defects in the macro-section, shown in FIG. 14.

### Discussion

Welds were made with different flow stress values in 25-mm and 50-mm 7075, which identified a flow stress threshold below which defects were observed. This threshold was simply based on post-weld visual inspection of surface-breaking defects. It is expected that a somewhat higher quality threshold will be indicated once full post-weld testing is completed. Future research may identify similar thresholds for other alloys, which will be most useful for broad application of flow stress control in industry and research.

There are limitations to the use of flow stress for control applications. For welding procedures that require tilting the welding tool relative to the workpiece, there is often incomplete contact between the shoulder and the workpiece. The current equations for calculating flow stress assume contact over the entire shoulder surface, so without some additional parameter representing the percentage of shoulder area in contact with the workpiece, the calculated flow stress will appear lower than actuality. This error will likely not preclude the use of flow stress control, since such an error in control will result in actual conditions that are further from producing “hot” defects.

Another limitation is related to excess flash. If excess flash is rubbing against the side of the welding tool and is sufficiently heavy, perhaps due to severe mismatch in the joint, the calculated flow stress will appear higher than actuality. This error would cause the controller to produce conditions that are closer to producing defects. Based on this, it may be necessary to restrict the allowable joint mismatch to safely use flow stress control in a production environment.

This work demonstrated that flow stress can be used as an indicator of weld quality, particularly for cases of low flow stress. However, a particular value of flow stress does not necessarily guarantee a sound weld. It is certainly possible to induce defects in a weld if, for example, a very low plunge force is used. Inadequate containment of the weld zone by forcible contact between the shoulder and the workpiece is still required, regardless of the observed spindle torque and calculated flow stress. The present work suggests maintaining a shoulder pressure that is some amount greater than the flow stress, although additional testing is required to fully establish the utility of this approach. Another way of producing defects, excessive joint gap, will produce volumetric defects regardless of the flow stress.

This work has not yet explored the production of volumetric defects associated with “cold” welding conditions that are characterized by high flow stress, generally from the low range of surface velocity. Welds were made at high flow stress in this study and characteristic defects were observed, but the results have not yet been thoroughly evaluated or confirmed.

Closed-loop control of welding tool temperature has been developed and shown to be capable of tightly controlling the conditions of welding in FSW, even in the case of variable boundary conditions. The relationship between peak temperature and torque is well described in the literature and torque is used in some of the temperature control methods to modulate the temperature. However, from the work described here it seems to be possible to simply control torque as a means of maintaining constant welding conditions without the need to “close the loop” on temperature. Flow stress is used here instead of torque simply to normalize the value with respect to tool geometry. The agreement between 25 mm and 50 mm 7075 with respect to a flow stress-based quality threshold seen here does suggest a possible universality within alloy systems. Additional work is required to test the universality of flow stress with respect to tool geometry, workpiece thickness and alloy.

### Conclusions

Unit-area analysis was developed as a means of analyzing a diverse collection of welding procedures, published in the form of a publicly accessible Data Set. This analysis provides more meaningful data features as inputs to machine learning research. Welding conditions with low average flow stress were identified as possibly leading to welding defects, both in the Data Set and in welding experiments in 25-mm 7075 aluminum. This was tested in welds made with different flow stress levels in 25-mm and 50-mm 7075 plates and a flow stress threshold of 22 MPa was identified based on visual inspections, although it is expected that a somewhat higher threshold will emerge as destructive testing is completed. Welds in variable-geometry plates were made with and without flow stress control by manually adjusting spindle speed and/or travel speed to hold constant torque. This approach successfully produced welds with no surface defects, and destructive testing is currently underway. These preliminary results suggest that flow stress control may be a viable process control method, with some noted limitations.

### Example 3

Friction stir welds are today controlled by specifying the spindle speed, travel speed and axial (plunge axis) position or load as the primary machine settings. Each of these parameters are typically servo controlled, ensuring that the machine precisely maintains these settings throughout each weld. In the traditional sense, these parameters are maintained by closed-loop (servo) control.

Problems arise when a given welding procedure, developed for plates of long length and uniform width, is used to weld a complex joint with changes in boundary conditions, such as is encountered when welding up to an edge, around a corner or past a hole. In these situations, the welding procedure with fixed settings cannot respond to these changes and will therefore not produce the expected joint strength or quality. Although the primary machine settings are precisely maintained, they are not responsive to changes in welding conditions and can be considered open-loop control with respect to welding conditions. It then becomes necessary to engage in a potentially costly process to iteratively modify the welding system program with changing machine settings as a function of position along the joint. This is the state of current FSW system control algorithms. Load control of the plunge axis is the only exception, since it does offer a degree of adaptability to welding conditions, such as adaptation to changes in workpiece thickness.

Temperature control has been developed in recent years as a method of closing the control loop of machine settings to respond to changes in welding conditions. This method typically uses a thermocouple embedded in the rotating welding tool and the torque or speed of the spindle is modulated to maintain a constant welding tool temperature. Since the welding tool is generally at a different temperature than the workpiece, this type of temperature control is used as an indirect control of welding zone peak temperature. Very high accuracy can be achieved by treating the welding tool temperature as a servo-controlled parameter.

Embodiments disclosed herein can monitor the torque exerted by the spindle as an indication of welding conditions. The rationale is that the spindle torque corresponds with the temperature at the tool/workpiece interface, so by maintaining constant torque, the conditions of welding at the interface are held constant. This is another indirect way to control welding zone peak temperature.

The flow stress control algorithms described below manipulate spindle speed and travel speed to maintain constant spindle torque, and hence, constant workpiece temperature. Typically, increasing the spindle speed increases the weld zone temperature and therefore reduces spindle torque. Increasing travel speed has the opposite effect, producing a drop in weld zone temperature and an increase in spindle torque. The algorithms described permit the welding system to respond to changing boundary conditions, such as welding past a large hole, while maintaining constant weld temperature.

An additional embodiment recognizes the equivalence of controlling spindle torque, welding tool temperature and calculated flow stress and generalizes the control algorithm to respond to deviations for any of these three control variables. A further improvement modifies the algorithm to avoid the degradation of joint properties that can occur in cases where changes in boundary conditions result in reduced cooling rate in the weld zone.

### Flow Stress Control

Closed-loop control that responds to changes in welding conditions can be performed by simply manipulating the spindle speed and/or the travel speed to hold the spindle torque constant at some predetermined setpoint. However, the optimum spindle torque value is a function of the welding tool geometry, including the length of the welding tool pin. In FSW the pin is typically slightly shorter than the workpiece thickness. As a result, using torque as the control setpoint means that for every welding tool design, including every workpiece thickness, the optimum torque value would have to be determined before this type of control can be used.

There is a way of deriving the optimum torque for a given welding tool from an estimate of the average flow stress at the tool/workpiece interface. Imagine a weld is made in a given workpiece material with some welding tool design. The observed spindle torque can mathematically be equated to an average contact shear stress that is assumed to be distributed over the tool/workpiece interface. This contact shear stress is conventionally converted to a normal flow stress that appears to be distributed over the entire interface. This optimum flow stress value can then be used with any new tool design to estimate the optimum spindle torque for the new tool. In this way, an optimum welding procedure can be used as the basis for a welding procedure in a different workpiece thickness or with a different welding tool design.

This method of controlling welds based on the average distributed flow stress has been shown to apply to welds of different thickness in a single alloy and has been shown to be a reliable basis for controlling welds with changing boundary conditions, in the form of changing workpiece geometry. Limited results with different alloys, and even with different materials, have shown that similar values of flow stress are useful for control purposes to ensure weld quality. The universality of a particular value or range of values for flow stress should be tested in a broad variety of workpiece materials and thickness.

It should be noted that flow stress control is not a panacea for ensuring top-quality welds. For example, it is certainly possible to produce a defective weld at a flow stress value that has produced high quality welds in the past. For example, if the welding tool's pin is slightly too short for a given workpiece thickness, a lack of consolidation in the root of the weld may result without significantly deviating from the optimum flow stress. Similarly, if the plunge force or depth is not adequate to fully contain the softened material in the weld zone, volumetric defects may be produced while holding a qualified flow stress value. Excessive spindle speed and travel speed may also produce weld defects at optimum flow stress values. For this reason, other control limitations on the welding process are needed to ensure sound welds.

### Flow Stress Control Functional Description

The principle of flow stress control can be implemented in welding machine controls in various forms, depending on the control features included. Some configurations of flow stress control will be described below, in order of increasing complexity. The algorithms presented may be implemented using servo control methods or may be implemented in the simple forms shown here.

In the descriptions of control schemes that follow it is assumed that the needed welding procedure details are provided by the user. Each algorithm assumes the user will provide the initial spindle speed and welding speed, and the forge axis position or force. For flow stress control, the flow stress setpoint should be provided, for temperature control the temperature setpoint should be provided and for torque control the torque setpoint should be provided. For algorithms that employ weld pitch control, the pitch setpoint, the maximum pitch and the minimum pitch should be provided, as needed. For flow stress control, it is assumed that the user will provide the first moment of area for the welding tool, referred to as “parameter G”, below.

Algorithms that employ flow stress control will need the equation for calculating flow stress from the first moment of area, G, and the measured spindle torque. The flow stress can be calculated from,

$${σ}_{flow} = \sqrt{3} \frac{T}{G}$$

where, T=spindle torque and G=first moment of area. G is calculated as the integral of the radius over the tool/workpiece interface area,

$$G = {\int }_{s} r dA$$

The details of the integral form are dependent on the geometry of the welding tool 106/workpiece 104 interface. For example, for a welding tool 106 with an inward or outward tapered or flat shoulder profile, a frustrum or cylindrical pin and a flat pin tip,

$$G = \frac{2 π}{3} [ \frac{{S}^{3} - {P}_{r}^{3}}{cos α} + \frac{t ( {( {P}_{R} + {P}_{T} )}^{2} - {P}_{R} {P}_{T} )}{cos β} + {P}_{T}^{3} ]$$

where,
α=shoulder taper angle
β=frustum probe half angle
S=shoulder radius
P_{R}=probe root radius
P_{T}=probe tip radius
t=workpiece thickness, or probe length

Note that in the algorithms described below, all checks for equality are associated with some tolerance band and all parameter changes are assumed to have some increment size, to be determined upon implementation of the algorithm. The tolerance band for equality should be much smaller than the increment size for each variable to ensure that equality is not overlooked by the algorithm.

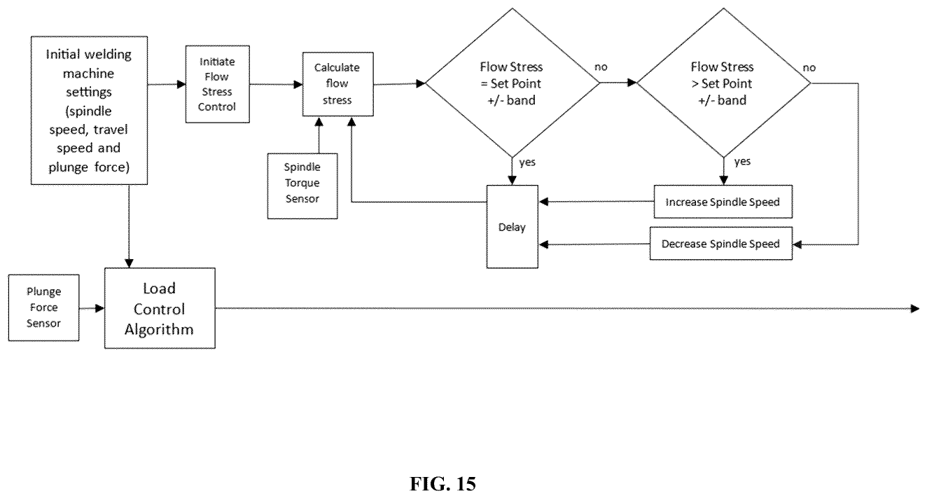

An exemplary basic form of flow stress control is shown in FIG. 15. The assumption is that the weld will be started and allowed to travel some distance before enabling the flow stress control algorithm, either by manually activating the control or within program control, although it is possible to switch into flow stress control immediately upon starting travel of the welding tool. This scheme uses the welding tool geometric features and the measured spindle torque to calculate the flow stress, then compares the flow stress to the flow stress setpoint and manipulates the spindle speed to correct the measured flow stress to equal the setpoint. Throughout the weld, it is assumed that control of the plunge axis will be accomplished independently in load or position control, as is normally done on most FSW machines. This algorithm may best be implemented with upper and lower limits on the spindle speed, preventing the spindle from excessive speed variations. Spindle speed is used in this algorithm, as opposed to travel speed, since it has been shown that spindle speed has a greater, and faster, influence on flow stress.

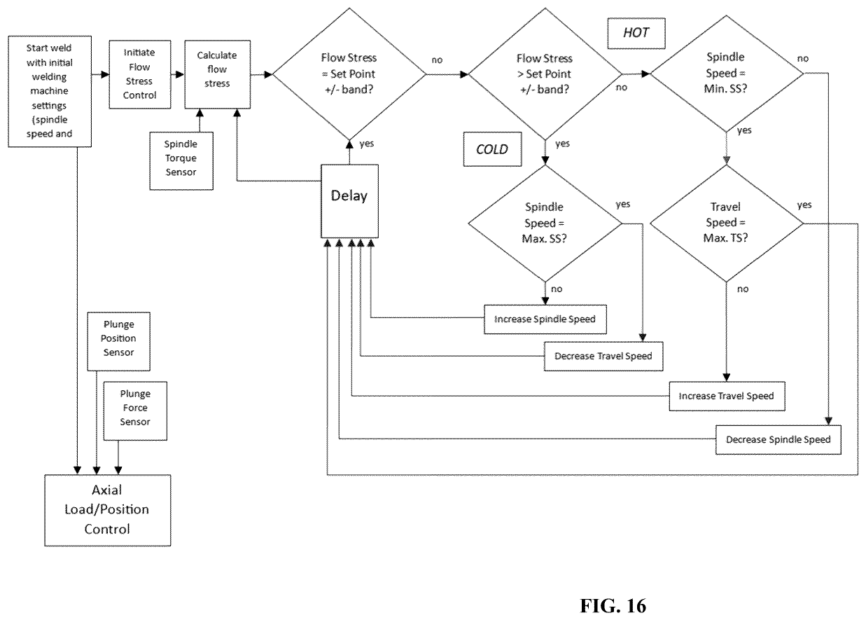

Referring to FIG. 16, a second flow stress control algorithm can be described as flow stress control with spindle and travel speed modulation, within limits. This form of the algorithm prioritizes spindle speed modulation until a spindle speed limit is reached (high or low), then modulates travel speed to yield an additional range of flow stress manipulation. As in the previous algorithm, control of the axial force or position is assumed to be handled by traditional plunge axis control methods.

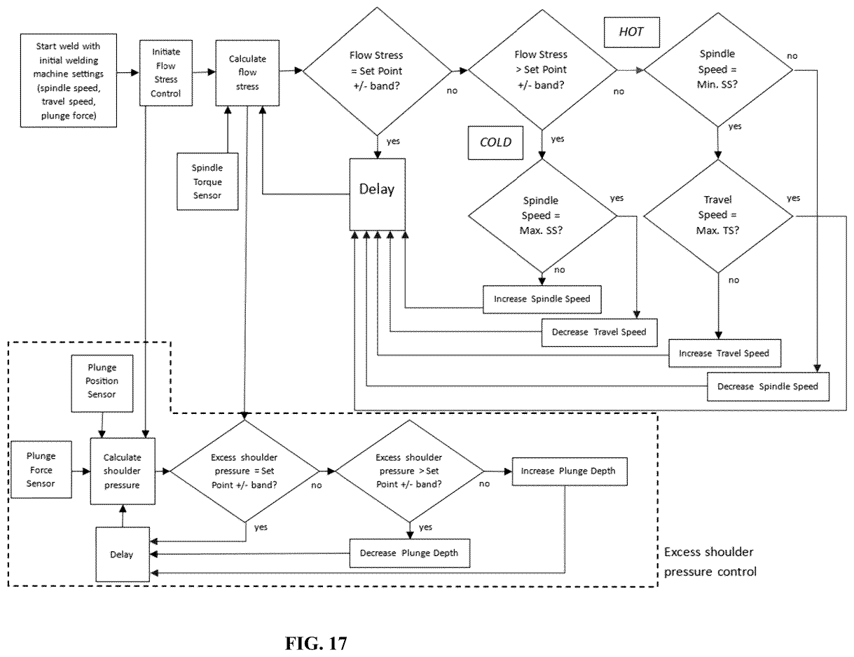

Referring to FIG. 17, a third flow stress control algorithm can modify the axial load control scheme from simply manipulating plunge axis position to hold a force setpoint. Here, the welding tool geometry is used to calculate the shoulder pressure (plunge force divided by the tool area based on the shoulder diameter). This is then used to calculate the excess shoulder pressure as the shoulder pressure minus the flow stress. This data feature has been shown to be useful for scaling the plunge force setpoint to the welding tool geometry and the conditions of welding (flow stress), making it possible to use a more universal expression of plunge force. The manipulation of spindle speed and travel speed are handled the same as in the previous algorithm.

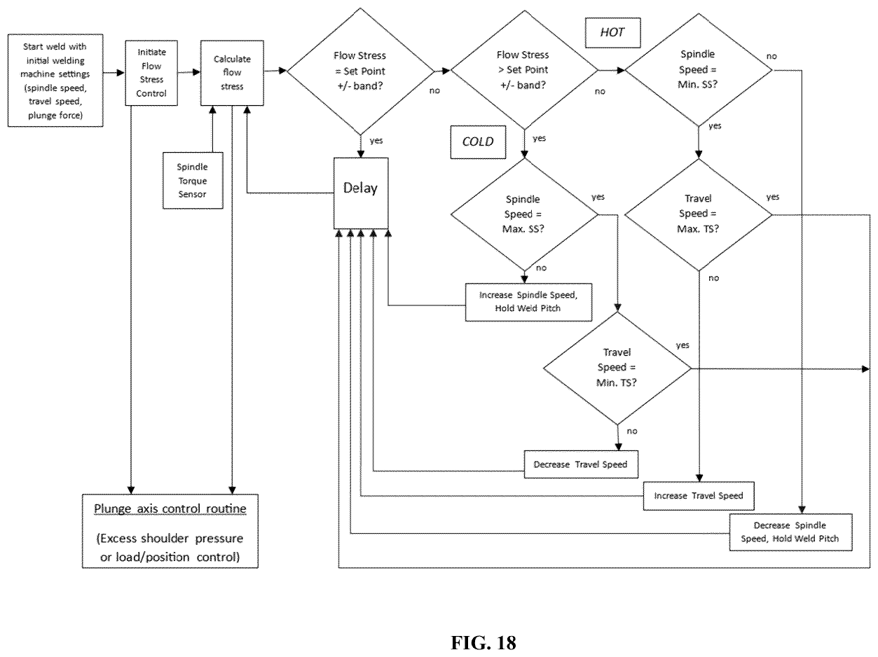

The next exemplary flow stress control algorithm, shown in FIG. 18, adds a relationship between spindle speed and travel speed. The previous versions of the algorithm treated spindle speed and travel speed independently, which works well enough for small ranges of each variable. However, a simple relationship between the travel speed and the spindle speed can be imposed so that they are both changed at the same time. One such relationship is known as weld pitch, calculated as the ratio of travel speed to spindle speed. The weld pitch has been shown to be inversely proportional to the amount of energy transferred to the workpiece per unit swept volume of material, referred to as the energy density (units of joules per unit volume). Using this in the algorithm, when the flow stress drops, indicating hotter welding conditions, the spindle speed and travel speed are both reduced, maintaining constant weld pitch and constant flow stress. Note that when the spindle 108 speed reaches a pre-programmed limit while the welding speed has not reached its limit, the algorithm permits deviation from the weld pitch setpoint to achieve additional response to a deviation from the flow stress setpoint.

There is a technical reason for maintaining constant weld pitch. Each welding tool 106 design has a limited tolerance to increases in weld pitch. Previously described flow stress control algorithms respond to “hot” welding conditions by decreasing the spindle 108 speed, which necessarily increases the weld pitch (welding speed divided by spindle speed). As the pitch increases, there is a point at which weld quality will degrade, resulting in low tensile ductility in the heat-affected zone, volumetric defects and reduced tensile strength. The algorithm shown below avoids this risk by maintaining constant weld pitch, thus manipulating spindle speed and welding speed in a constant ratio.

In this and subsequent algorithms, it is assumed that the initial spindle speed and welding speed are appropriate for the pre-defined weld pitch setpoint. Alternatively, the initial machine settings can be automatically transitioned to produce the weld pitch setpoint when adaptive control is started.

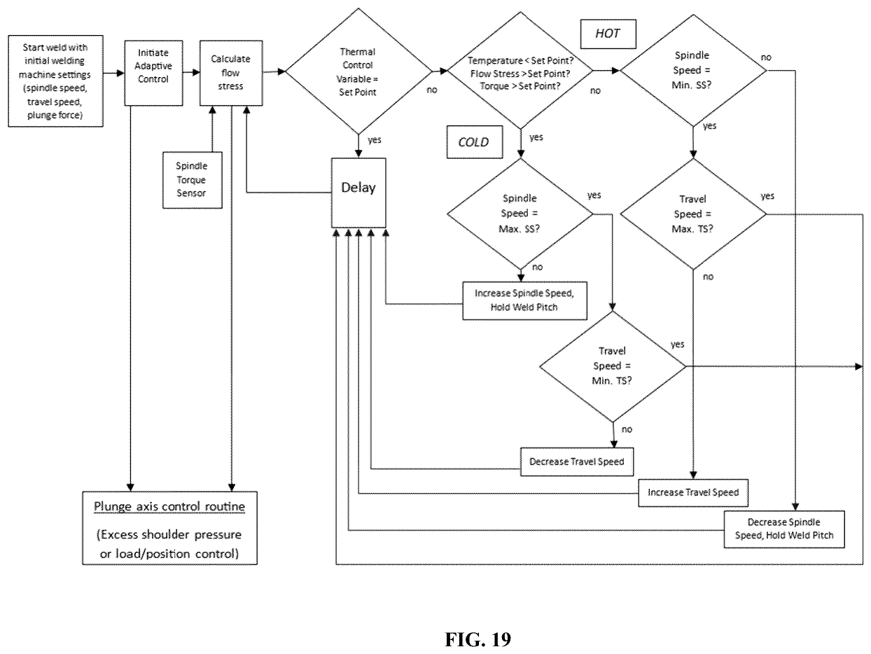

FIG. 19 shows an exemplary flow stress control based on an algorithm that accounts for equivalence of torque, flow stress and welding tool temperature as indirect indicators of the temperature at the welding tool 106/workpiece 108 interface. Based on this equivalence, the algorithm permits selection of any of these variables as the primary control variable for maintaining weld quality with changes in thermal boundary conditions. This can be considered a generalized adaptive control algorithm. This version of adaptive control permits the user to input a setpoint for flow stress, spindle torque or temperature, referred to collectively as the thermal control variable setpoint. The version shown below demonstrates generalized adaptive control using a thermal control setpoint as the control variable along with the desired weld pitch, manipulating spindle speed to hold the selected setpoint, and manipulating welding speed to maintain constant weld pitch. Note that when the spindle speed reaches a pre-programmed limit while the welding speed has not reached its limit, the algorithm permits deviation from the weld pitch setpoint to achieve additional response to a deviation from the thermal control variable setpoint.

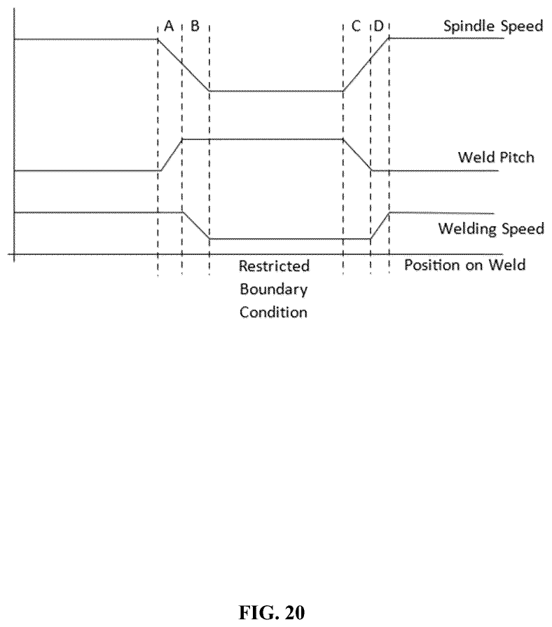

FIG. 20 shows an exemplary adaptive control with modified pitch control in response to a restricted boundary condition. This adaptive control algorithm produces welds with a constant thermal control variable and manipulates weld pitch in a way that results in higher joint strength in conditions of increasing thermal boundary condition constraint, i.e., hotter welding conditions. Experiments have shown that in a condition where the thermal boundary condition surrounding a weld is becoming more restrictive, the previously described algorithm produces defect-free welds with constant weld pitch, but since a more restrictive boundary condition has a slower cooling rate, the transverse joint strength may decrease. The lower cooling rate subjects the material near the joint to high temperature for a longer duration, resulting in increased metallurgical degradation.

To avoid the added metallurgical degradation from a more restrictive boundary condition, the present algorithm permits variation in weld pitch within a range. As the welding tool 106 approaches a region with a more restrictive boundary condition, the increased weld zone temperature causes the algorithm to reduce the spindle speed. Previous algorithms that held constant weld pitch proportionally decreased the welding speed to maintain constant weld pitch. To offset the additional metallurgical degradation arising from the more restricted boundary condition, the present algorithm holds constant welding speed as the spindle speed is reduced, permitting the weld pitch to increase until some pre-programmed maximum value is reached. This has the effect of reducing energy density, offsetting to some degree the added metallurgical degradation. When the boundary condition becomes less restrictive, the algorithm returns to the original pitch setpoint or holds to a pre-programmed minimum pitch value.

Experiments have also shown that a particular welding tool design has a limited tolerance for weld pitch, beyond which degraded weld quality is produced. The algorithm described here permits the weld pitch to increase when spindle speed is reduced (section A in FIG. 20) by holding the welding speed constant until the weld pitch reaches the prescribed maximum weld pitch, presumably below the “pitch tolerance” of the welding tool. The increased weld pitch results in lower energy density, offsetting to some extent the degradation of joint properties produced by the slower cooling rate. Once the maximum pitch is reached and held, further decreases in spindle speed will result in proportional decreases in welding speed to hold the weld pitch at the maximum pitch value (section B in FIG. 20). When the spindle speed is subsequently increased, presumably in response to an expansion in thermal boundary conditions, the welding speed will be held constant as the pitch decreases until the original pitch set point is reached (section C in FIG. 20), at which point the welding speed will increase proportionally to changes in spindle speed, holding the pitch at the original pitch setpoint.

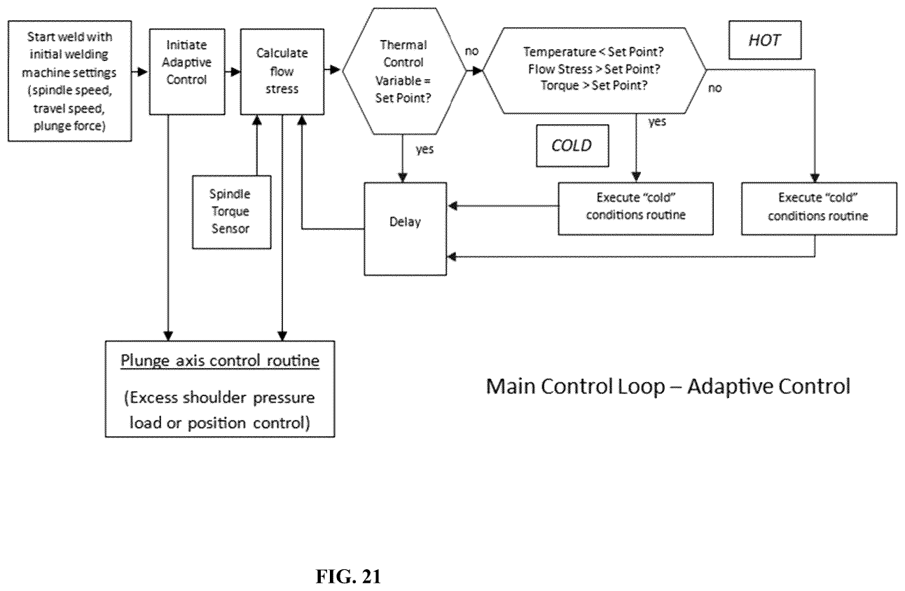

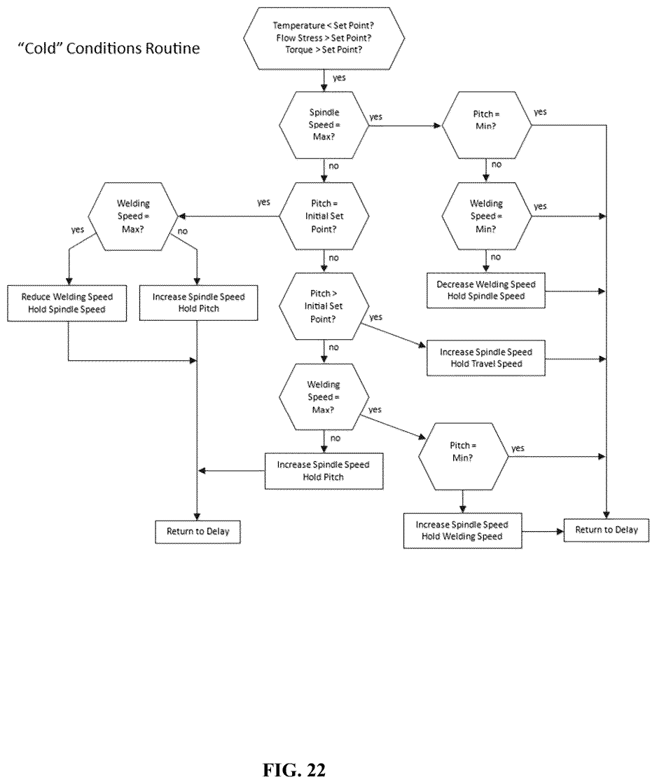

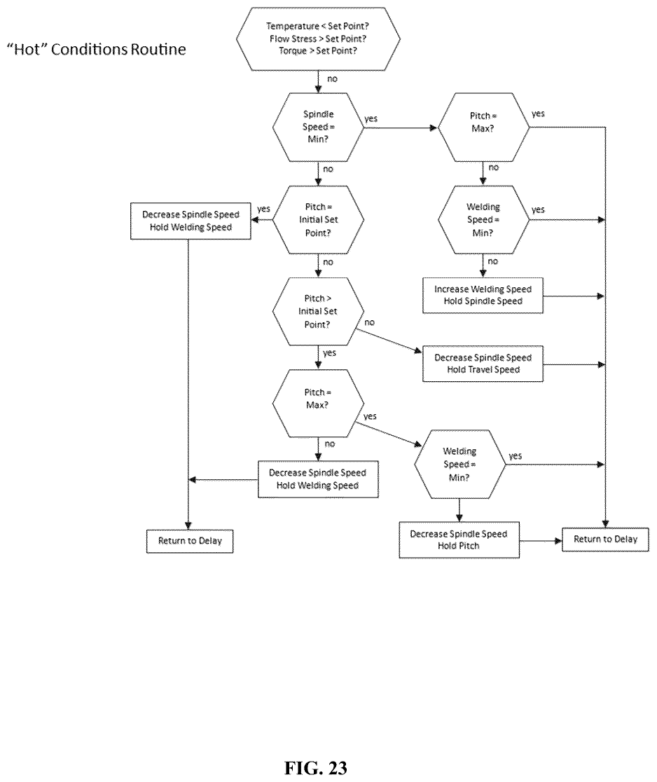

FIG. 21 shows an exemplary adaptive control main algorithm with modified pitch control, with subroutines for “hot” and “cold” conditions. Due to the increased complexity of this adaptive control algorithm, the responses to “cold” or “hot” welding conditions are described in the form of subroutines that each return to the “delay” step in the main algorithm. FIG. 22 shows an exemplary adaptive control algorithm with modified pitch control for a “cold” conditions subroutine. FIG. 23 shows an exemplary adaptive control algorithm with modified pitch control for a “hot” conditions subroutine.

### Example 4

Macro sections from friction stir welds in 25-mm 7075-T6 aluminum were analyzed to study possible relationships between unit-area quantities (such as average flow stress, lateral pressure, shoulder pressure, heat flux and energy density), basic forces, and the internal structure of the welds. Various features of the sections were examined, including stir zone size and shape, distortion of the grain structure outside of the stir zone and the presence of volumetric defects. This analysis was part of a continuing program to develop unit-area analysis as a means of gaining additional insight into the welding process with possible implications for machine learning and advanced welding controls.

The examination of macro-etched cross sections from friction stir welds (FSWs) is a common way of directly visualizing the internal structure produced, both for scientific investigations and for welding procedure qualification. For procedure qualification it is often used for assessing the volumetric soundness of a weld and for assessing the completeness of weld penetration, for example. The study of macro sections has also been used to gain insight into the flow of workpiece material as welds are formed. This technique has been augmented by the addition of tracer materials, such as dissimilar alloys or materials, into the joint at different positions.

Stir zone (SZ) formation is strongly dependent on the design of the welding tool. The original FSW tool designs generally consisted of a smooth, inwardly tapered shoulder and a cylindrical probe with threads and a spherical tip. These tools generally produced a rounded SZ that was significantly wider than the diameter of the probe. The probe style used in the present study employed a flat shoulder with spiral grooves that pull workpiece material toward the center and a frustum-shaped probe with threads and flats and a flat tip. This style offers several advantages, including improved performance in thick-section welding, the ability to weld without tilting the welding tool and improved penetration of the SZ beyond the tip of the probe. The SZ shape produced by this style of tool more closely matches the profile of the probe, implying more efficient transfer of workpiece material made possible by the interaction of the threads and flats with the workpiece.

Features observed in the examination of macro sections can be categorized as arising from geometric sources or from metalworking issues. Geometric sources include remnant oxide, arising from inadequate probe length, joint misalignment or excessive shoulder diameter. A common geometric issue comes from inadequate plunge depth, evidenced by a raised weld crown surface in relation to the surrounding parent material and accompanying internal voids due to the reduction in material volume under the tool, defects produced by low heat input, and inadequate SZ penetration.

Aside from geometric considerations, there are metallurgical and metalworking considerations that produce features that are exposed in macro section examination. Friction stir welding is a bulk metalworking process, and as such, must produce within the workpiece conditions that are within the material's workability limits. At a given processing temperature and stress state, extreme deformation of the material must take place within these limits, which defines the strain and strain rate that are possible without fracture. State-of-stress workability recognizes the importance of hydrostatic stress components for enhancing the workability of a given process. Intrinsic workability deals with the initial microstructure and alloy chemistry of the workpiece, and the changes in microstructure that are produced as part of the metalworking process. Although many metalworking processes and materials have been extensively studied in relation to the limits of workability, friction stir welding has not yet been adequately subjected to such scrutiny.

Unit-area analysis is being developed as a means of normalizing the basic features of the FSW process with respect to workpiece thickness. One goal can be to resolve the tool geometry, forces and spindle torque in a way that permits comparison between procedures executed in different material thickness. To facilitate study of different welding procedures, unit-area analysis seeks to convert “global” quantities to “unit-area” quantities. For example, unit-area analysis provides a means to reduce the measured spindle torque to an equivalent uniformly distributed shear stress, then to the equivalent flow stress at the tool/workpiece interface. This may provide an equal basis on which to analyze a diverse collection of welding procedures.

Unit-area analysis depends on mathematically reducing the welding tool geometry to a single quantity, referred to as G (for geometry). This parameter is calculated as the integral of the radius over the tool/workpiece interface area. The expression for G is dependent on the style of welding tool used. For example, for a flat or tapered shoulder with a flat-tipped, frustum-shaped probe, the expression for G is,

$$G = \frac{2 π}{3} [ \frac{S - P}{cos α} + \frac{t ( ( P + P ) - P P )}{cos β} + P ] \qquad ( 13 )$$

where,
α=shoulder concavity angle
β=frustum probe half angle
S=shoulder radius
P=probe root radius
P=probe tip radius
r=dimension in radial direction
z=dimension along probe axis
t=workpiece thickness, or probe length
θ=anglular position

From this, expressions for the average flow stress, area-based average surface velocity, heat flux and energy density can be derived.

To compare welding procedures in terms of spindle speed and welding speed, comparable expressions are used in this work that seek to normalize these basic machine settings in terms of an area-based surface velocity and volume-based travel speed. The average surface velocity is expressed as,

$$ω \overline{r} = ω \frac{G}{total area} \qquad ( 14 )$$

where ω is the angular velocity and r̅ is the average radius. The equivalent to welding speed used here is volumetric flowrate, FR, which is simply calculated as

$$F R = ν t ( P + P ) \qquad ( 15 )$$

The unit-area expression used in the present work as an equivalent to spindle torque is flow stress, σ_{flow},

$${σ}_{flow} = \frac{T \sqrt{3}}{G} \qquad ( 16 )$$

where T is the spindle torque. Shoulder pressure, SP, is simply the plunge force, F_{plunge}, divided by the shoulder area,

$$S P = \frac{{F}_{plunge}}{π S} \qquad ( 17 )$$

where S equals the shoulder radius. The lateral pressure on the probe, LP, is expressed as the lateral force divided by the lateral area of the probe. For a frustum-shaped probe with a flat tip, the lateral pressure is,

$$L P = \frac{\overline{{F}_{longitudinal} + {F}_{t ansve se}}}{t * ( P + {P}_{t} )} \qquad ( 18 )$$

where F_{longitudinal} and F_{t ansve se} are the longitudinal and transverse forces on the welding tool, respectively. The heat flux is the power output per unit area of the tool/workpiece interface, and is proportional to the average temperature gradient at the interface. The heat flux, φ_{q}, with units of power per unit area, is calculated as,

$${ϕ}_{q} = \frac{T}{G} \times ω \overline{r} \qquad ( 19 )$$

Early research in FSW attempted to normalize heat input based on the total power output and the travel speed, yielding “specific energy”. However, this formulation did not account for differences possible with respect to workpiece thickness. To improve the expression of the energy put into the workpiece, in terms of volume of processed material, the energy density can be calculated as shown below, with weld pitch calculated as the travel speed divided by the spindle speed. Energy density is proportional to the temperature distribution in the workpiece. Two expressions for energy density are possible. The first expression, ρ_{E1}, is based on the lateral probe area.

$${ρ}_{E 1} = \frac{{ϕ}_{q} \times ( total tool area )}{F R} = \frac{2 π T}{weld pitch \times ( lateral probe area )} ( units : energy per unit volume ) \qquad ( 20 )$$

There is a second possible expression of energy density, ρ_{E}, based on the total tool area, is shown below. This second expression is the version of energy density used in the present work.

$${ρ}_{E 2} = \frac{{ϕ}_{q}}{travel speed} = \frac{2 π T}{weld pitch \times ( total tool area )} ( units : energy per unit volume ) \qquad ( 21 )$$

An additional data feature developed as part of this work is referred to as excess shoulder pressure. This feature seeks to normalize the plunge force based on the flow stress. The excess shoulder pressure, ESP, is expressed as the shoulder pressure, SP, minus the flow stress, FS,

$$E S P = S P - F S \qquad ( 22 )$$

The present work is part of a larger effort to develop advanced controls and machine learning techniques to reduce the level of expertise required to implement FSW in a production environment by improvements in machine control. As part of this work, welding experiments that included a wide scope of machine settings were conducted and analyzed with the goal of developing new data features that expressed welding conditions in a way that could be used to advance the program goals. This work summarizes the analysis of macro sections from these welds and seeks to correlate weld formation with the various data features from unit-area analysis.

In this study, welds were made with the objective of mapping the effects of machine settings to a broad variety of results. Unit-area quantities were calculated from the measured axis forces and spindle torque. Post-weld evaluations included visual inspection of the weld crown, quantitative assessment of excess flash production, examination of macro sections, assessments of tensile tests, and inspection from phased-array ultrasonic and radiographic methods. The macro sections were photographed using a light macroscope at low magnification. One goal was to correlate unit-area quantities with weld outcomes as input to the development of advanced controls and machine learning approaches.

Bead-on-plate welds were made in 25-mm thick by 305-mm wide by 1,016-mm long 7075-T6 aluminum plates that were each bolted to a steel welding fixture. Each weld was made with either constant welding speed or constant spindle speed, according to the experimental plan. The welding tool dimensions are given in Table 4. The two-piece welding tool was adjusted to give a 0.5-mm gap between the pin tip and the anvil.

TABLE 4
Welding tool details.

| Shoulder material | Viscount 44 (resulferized H13 tool steel) | |
|---|---|---|
| Pin material | MP-159 (Co—Ni) | |
| Shoulder description | Flat, three spiral scrolls | |
| Pin description | Frustum, flat tip, threaded (1.81 mm | |
| | pitch) with 5 flats | |
| Shoulder diameter | 35.56 | mm |
| Pin root diameter | 21.01 mm (typical) | |
| Pin tip diameter | 12.7 | mm |
| Pin length | 24.94 mm (typical) | |
| G | 2.14EE−5 | m\hat{ }3 |
| Total tool surface area | 2.11EE−3 | m\hat{ }2 |

Four series of welds are presented, as summarized in Table 5.

TABLE 5
Basic machine settings for four welding test series.

| | Spindle Speed - | Welding Speed - |
|---|---|---|
| | Surface Velocity | Volumetric Flowrate |
| Test | Range | Range |
| Series | rev/min (m/s) | mm/s (mm\hat{ }3/s) |
| 1 | 70-305 | 1.27 |
| | (0.075-0.32) | (535) |
| 2 | 148 | 0.42-2.12 |
| | (0.157) | (178-893) |
| 3 | 89 | 0.64-2.12 |
| | (0.095) | (266-893) |
| 4 | 227 | 0.64-1.91 |
| | (0.241) | (266-801) |

Each series had welds made in position control and in load control, although not all results are presented here. For welds made in position control, where a constant plunge depth was maintained with different machine settings, the measured plunge force was considered an output from the machine spindle speed/travel speed combination. In welds made in load control, the results were regarded as the result from the machine settings at the given plunge force. Each weld was made with between four and six segments of stable machine settings. Subsequent log file data analysis isolated segments of stable input conditions and output forces and average values were calculated from the basic force data which were then used to calculate unit-area analysis quantities of flow stress, heat flux and energy density.

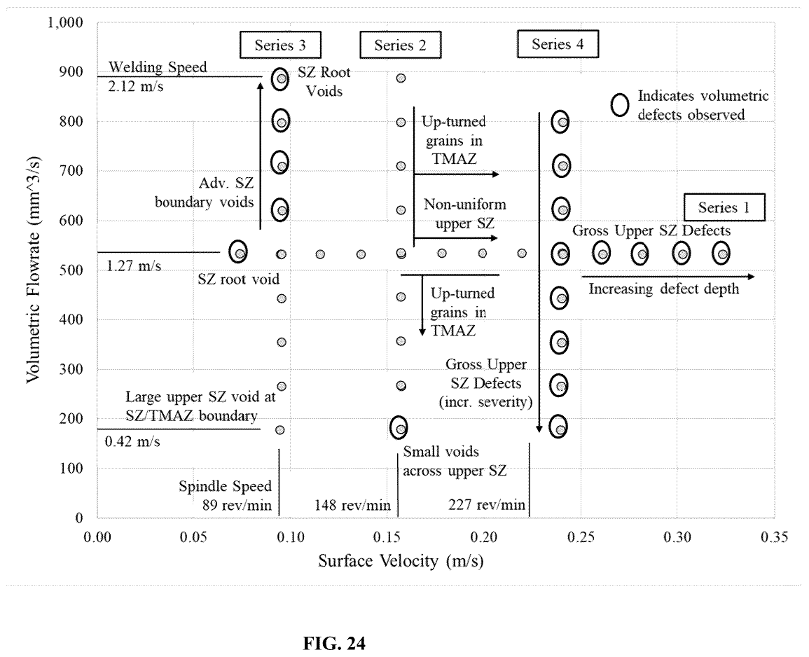

FIG. 24 shows a map of the four series of welds made as a function of the basic machine settings of spindle speed and welding speed. Welding conditions that exhibited volumetric defects are circled and trends in macro-section observations are noted in the figure. As expected, extremes of travel speed and spindle speed generally exhibited volumetric defects and variation in tensile strength, as will be discussed below in detailed reviews of the four series of welds. The reviews of each weld series attempt to correlate the macro sections with changes in the unit area quantities.

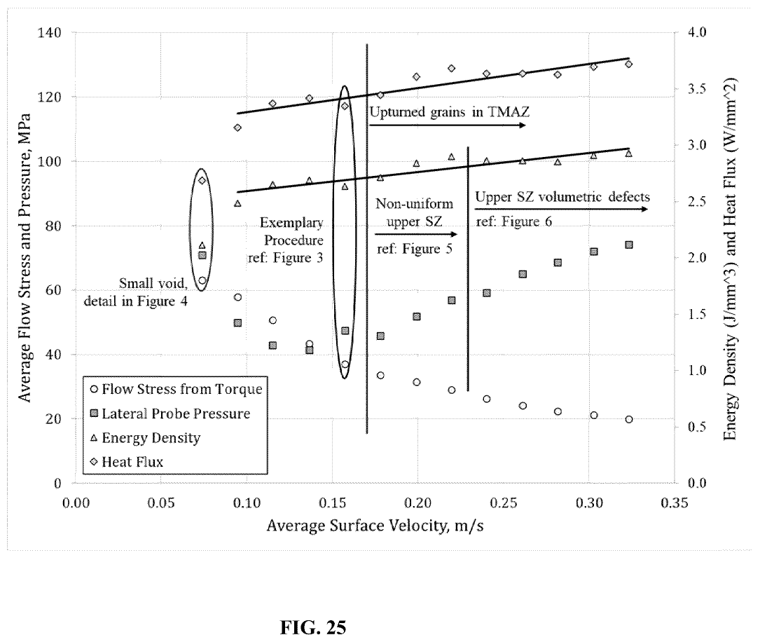

The average flow stress, energy density and lateral probe pressure for Series 1 welds is shown in FIG. 25. These quantities are plotted as a function of average surface velocity, with all welds having been made at a constant welding speed of 1.27 mm/s (535 mm\hat{ }3/s volumetric flowrate). In this chart the flow stress is seen to trend downward with increasing surface velocity. It has previously been shown that flow stress trends linearly with respect to the inverse of the surface velocity for welds that exhibit a linear trend in heat flux with respect to surface velocity. Interestingly, the lateral pressure on the probe decreased with increasing surface velocity until a surface velocity of about 0.15 m/s, then increased with increasing surface velocity. The energy density and heat flux both increased linearly with respect to surface velocity, except for the procedure that had the lowest surface velocity where the energy density and heat flux were seen to deviate below the linear trend.

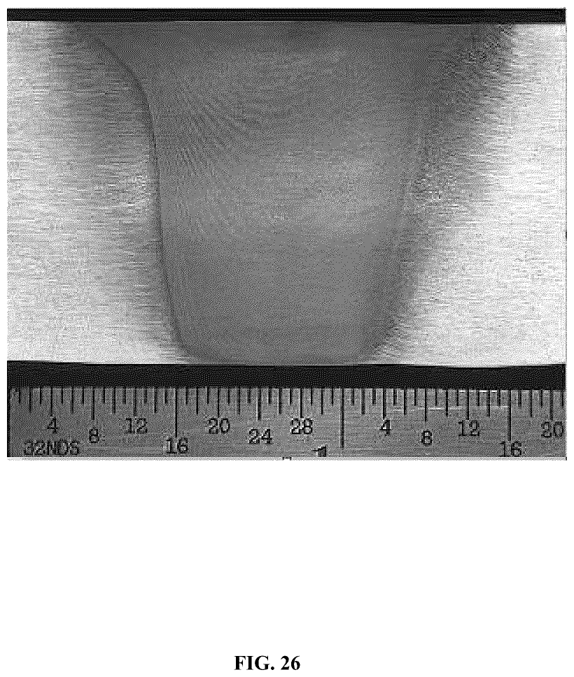

A macro section from an exemplary welding procedure is shown in FIG. 26. The conditions for this procedure were at the intersection between Series 1 and Series 2 welds, which coincidentally, is approximately at the minimum lateral probe pressure for Series 1. The general structure of the weld section is representative of welds made with this welding tool style, with the stir zone (SZ) boundary approximately following the probe profile, except in the upper portion of the SZ which smoothly blends outward to the shoulder width. It is notable that this style of welding tool produces a SZ that contrasts distinctly from the SZ produced by a welding tool with a cylindrical, threaded probe with no other reentrant features, such as flutes or flats, likely due to very different material flow produced by the different tool styles.

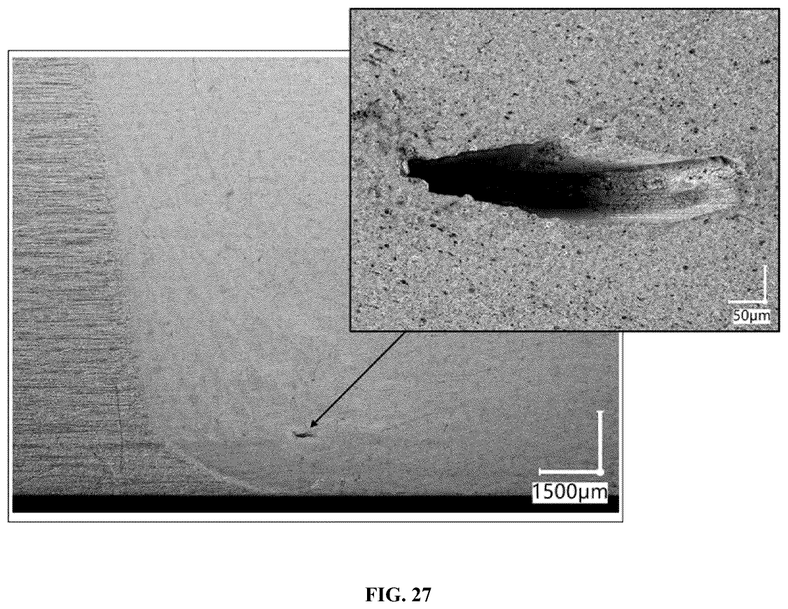

At the very lowest surface velocity in Series 1 a small volumetric defect was found in the lowest portion of the SZ, as shown in FIG. 27. Under higher magnification it appeared that a remnant of thread-shaped material could be seen inside the cavity, suggesting that the source of this defect was interruption of the normal consumption of the keyhole wall by extreme plastic deformation behind the advancing tool. The fact that this procedure exhibited energy density that was below the linear trend from higher surface velocities and high flow stress further supports the idea of inadequate plastic deformation, possibly due to low local temperature at the bottom of the weld.

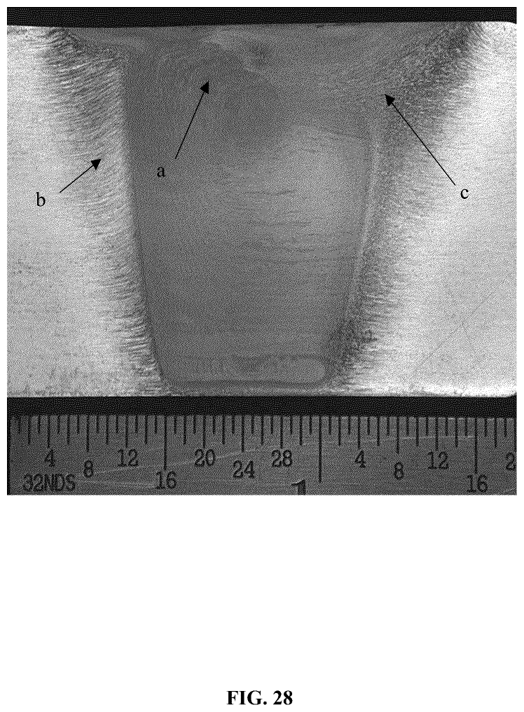

In Series 1, at surface velocities above about 0.16 m/s, all macro sections exhibited upturned grains in the thermomechanically affected zone (TMAZ) just outside of the SZ. Welds made at 0.178 m/s surface velocity (167 rev/min spindle speed) and higher also exhibited non-uniform structure in the upper SZ, as shown in FIG. 28.

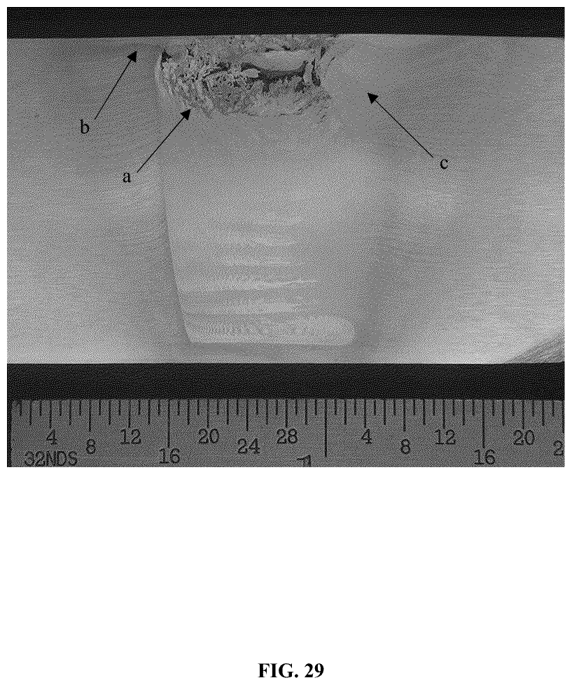

Welds at 227 rev/min spindle speed (0.241 m/s surface velocity) and higher all exhibited large voids in the upper stir zone which were packed with discontinuous fragments of parent material, as shown in FIG. 29. Post-weld visual inspection of the welds indicated a “surface tearing” appearance, but macro sections revealed that these voids were more extensive than a surface defect. It was also noted that these voids extended deeper into the weld as the surface velocity increased.

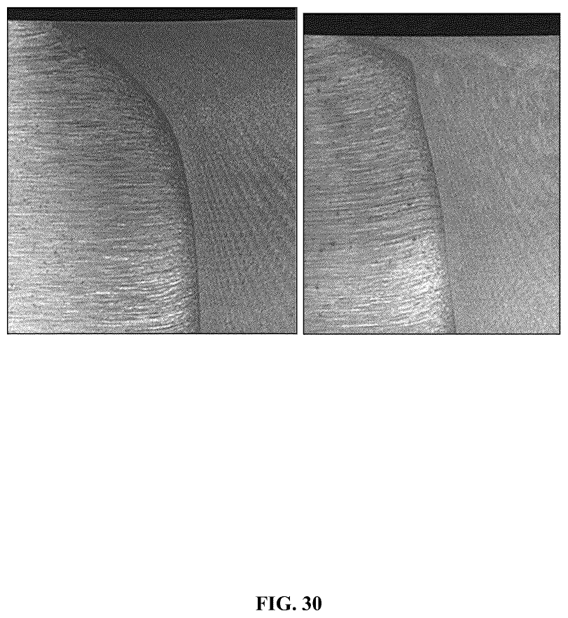

Welds above 0.16 m/s surface velocity also exhibited a distinct change in SZ shape in the shoulder region. FIG. 30 shows the sudden change in the shape of the upper advancing side of the SZ. At 0.157 m/s surface velocity and less, the SZ shape more smoothly transitions from the shoulder outside diameter to the pin profile shape. At 0.178 m/s surface velocity and above there was a sudden narrowing of the upper portion of the advancing side SZ, ultimately resulting in the shoulder producing very little SZ material, as seen for example in FIG. 24.

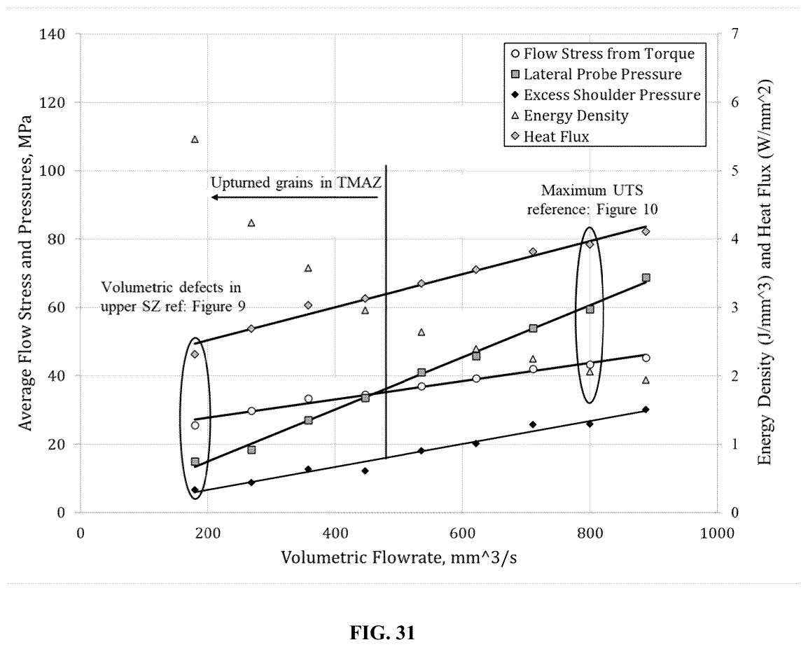

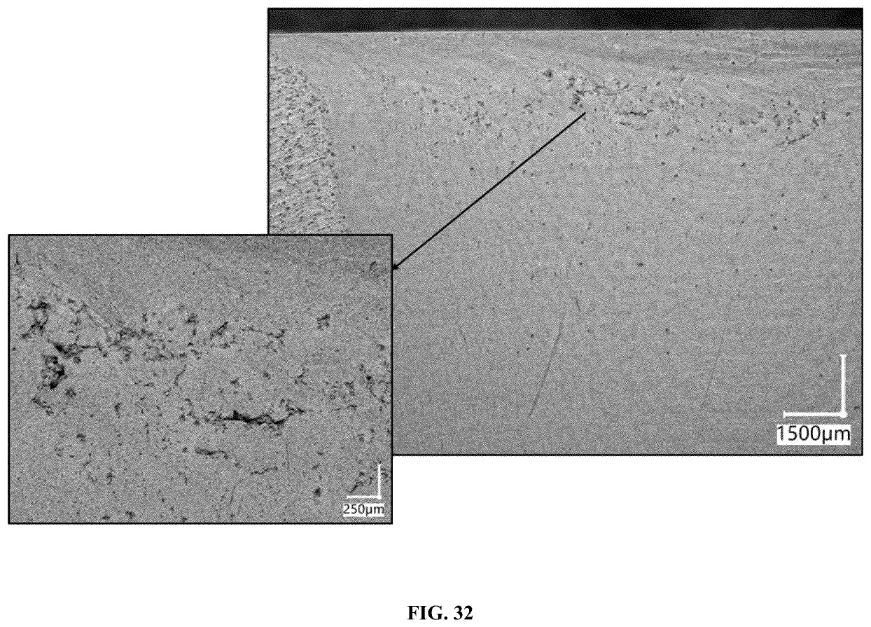

The average flow stress, energy density, lateral probe pressure, heat flux and excess shoulder pressure for Series 2 welds, made at a surface velocity of 0.157 m/s (148 rev/min spindle speed), are shown in FIG. 31. The welds reported here were made in position control. The only volumetric defect observed in the welds from Series 2, shown in FIG. 32, was from a procedure at the lowest welding speed. In that weld, a broad region of the upper SZ contained numerous, small volumetric defects. There was also a much shallower penetration of stir zone material from the shoulder, visible in the figure and similar to that shown in FIG. 30 (right side). The macro sections from welds made at below 450 mm\hat{ }3/s volumetric flowrate all exhibited upturned grains in the TMAZ just outside of the SZ, similar to that shown in FIG. 28.

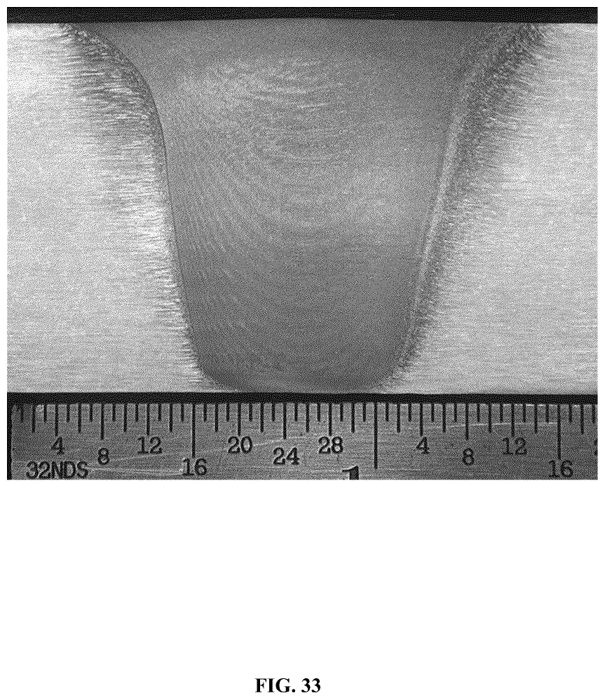

Series 2 welds exhibited the highest tensile strength values of all the welds produced. The highest tensile strength, 439 MPa, was produced at a volumetric flowrate of about 800 mm\hat{ }3/s (1.91 mm/s welding speed) and 0.157 m/s surface velocity (148 rev/min spindle speed). In that weld segment, the flow stress was 43.3 MPa. A macro section from that segment is shown in FIG. 33.

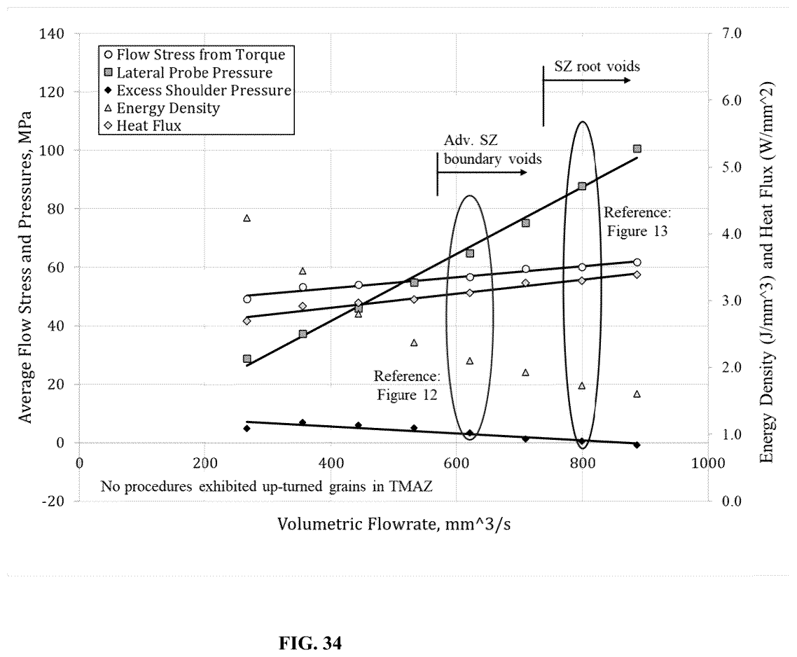

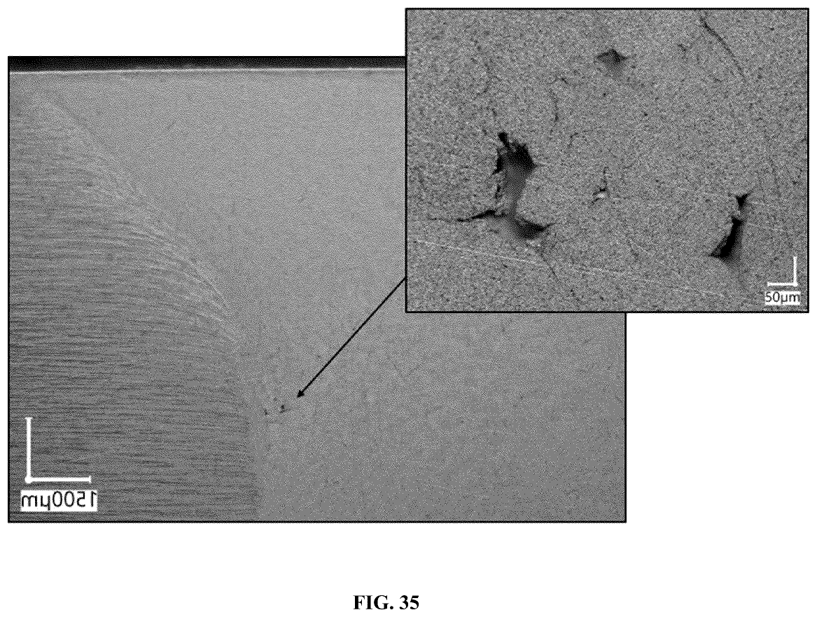

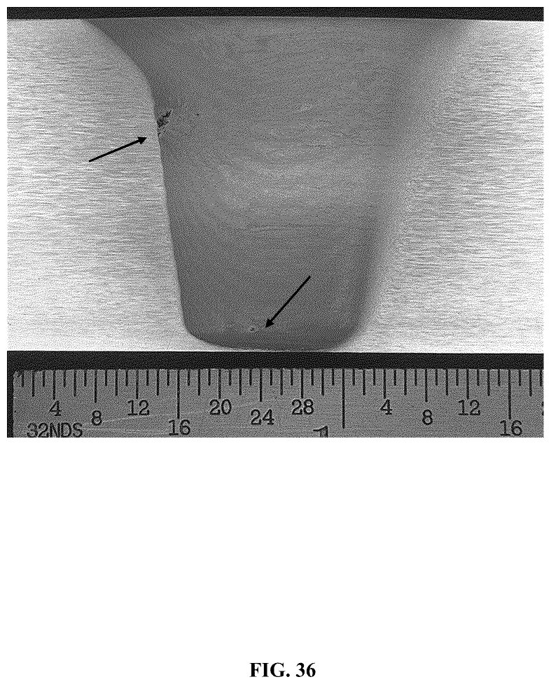

The average flow stress, energy density, lateral probe pressure, heat flux and excess shoulder pressure for Series 3 welds, made at a surface velocity of 0.095 m/s (89 rev/min spindle speed), are shown in FIG. 34. Welds were made in load control only in this series of welds. Defects were observed on the advancing side of the SZ in all welds made at about 600 mm\hat{ }3/s volumetric flowrate (1.48 mm/s welding speed) and higher, and additional defects in the root of the SZ were observed in welds made at a volumetric flowrate of about 800 mm\hat{ }3/s (1.91 mm/s welding speed) and higher. Examples of each type of defect are shown in FIG. 35 and FIG. 36, respectively.

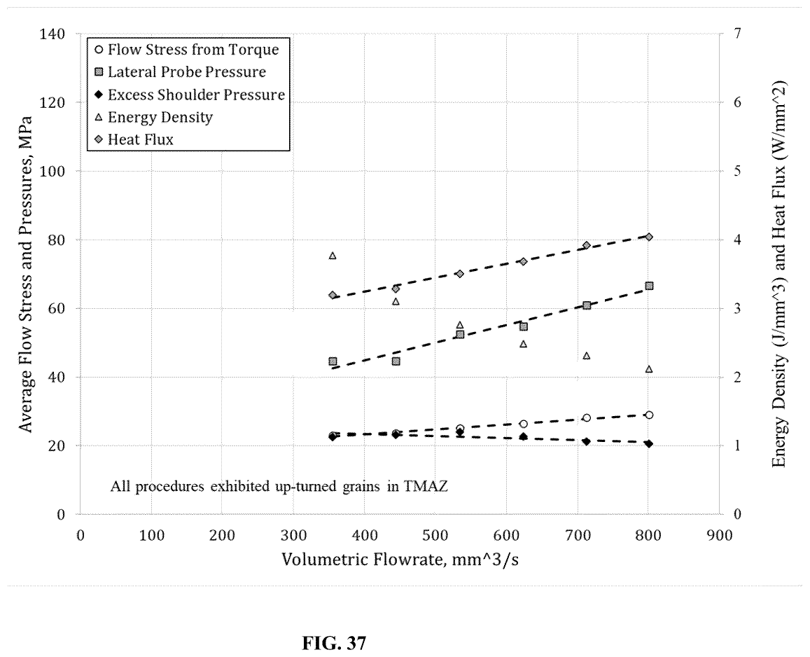

The average flow stress, energy density, heat flux, lateral probe pressure and excess shoulder pressure for Series 4 welds, made at a surface velocity of 0.241 m/s (227 rev/min spindle speed), are shown in FIG. 37. Welds were made in load control only in this series of welds. All welds made in this series exhibited defects in the upper SZ, similar to that shown in FIG. 29, which were visible at the time of welding. It is notable that as the travel speed increased, the severity of the defects decreased.

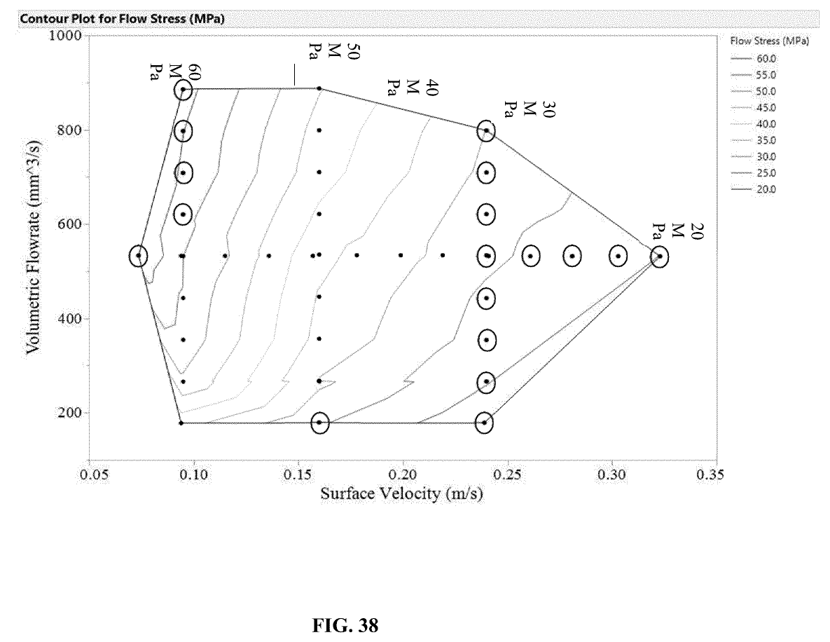

From these results it appears that average flow stress, calculated from tool geometry and spindle torque, is a reasonable indicator of defect formation for the tools and materials tested. In Series 1, as the surface velocity increased and the flow stress dropped to about 32 MPa, initial irregularities in the upper SZ were observed. As the flow stress dropped further in that series with increasing surface velocity, these indications worsened, eventually leading to volumetric defects at a flow stress of about 26 MPa. These defects increased in depth as the surface velocity increased and the flow stress decreased further. It does not appear that surface velocity is a sufficient indicator of weld quality for upper SZ defects in this range of machine settings. In Series 4 the upper SZ defects observed at low travel speed reduced in severity as the welding speed increased while the flow stress was also increasing, up to about 29 MPa, at constant surface velocity. FIG. 38 shows a contour plot of flow stress as a function of machine settings, overlaid with indications of procedures that had volumetric defects. Welding procedures with average flow stress above roughly 55 MPa and below roughly 30 MPa exhibited defects.

The results from welding Series 2, shown in FIG. 25, showed that as the spindle speed increased from a low value the lateral probe pressure decreased until a minimum value was reached at about 0.15 m/s surface velocity. As the surface velocity was increased further the lateral pressure increased continuously. A similar result was predicted by simulation results. It is speculated that this effect can be explained as follows. At low rotational speed, the rotation of the tool is too slow to assist in transporting material around the probe for the given travel speed. At such low spindle speeds material transport is dominated by extrusion, which explains the high lateral force. As the spindle speed increases, rotation of the probe contributes more to material transport, thus the decreasing lateral force, until a minimum force value is reached. The surface velocity that produces minimum lateral force can be considered an optimum value in terms of the efficiency of material transport which minimizes the dependence on extrusion for material transport. In the present study this was observed between 0.136 m/s and 0.157 m/s average surface velocity. With increasing surface velocity, the flow stress was seen to continue to decrease, suggesting increased thermal softening of the workpiece. As the surface velocity was increased above the optimum value, it is speculated that further increase in thermal softening reduced the rotational drag of material around the probe, resulting in a return to material flow dominated by extrusion and with that, increased lateral force. Evidence of this extrusion on the retreating side of the SZ is seen in FIGS. 28 and 29.

It is possible that the degradation of weld quality at surface velocities above the optimum value arise from a combination of state-of-stress workability and intrinsic workability failures. Increasing the surface velocity reduces the flow stress and presumably increases the peak temperature at the tool/workpiece interface. Increased surface velocity also is expected to increase the strain rate at the interface, simply because the features of the welding tool that induce plastic deformation are moving at increasing velocity. The state of stress may also play a role. In welds made with no shoulder (unpublished work), forward motion of the pin produced upwelling and loss of material in front of the pin. With the shoulder present, this tendency of the probe to push material upward may result in compression of material upward against the shoulder, which should produce some amount of hydrostatic stress against the shoulder and against the leading edge of the probe, reducing the tendency to fracture the material as it is deformed. As the surface velocity increases, with constant welding speed, this hydrostatic stress may become reduced, resulting in material fracture. Other mechanisms are possible, such as fracture initiating in the region behind the probe, where upwelling is not expected to play a role. Further experimental investigation is needed to properly explain this type of defect formation.

Defect formation at low surface velocity appeared to be of a different nature. At a surface velocity of 0.095 m/s and volumetric flowrates above 535 mm\hat{ }3/s voids initially appeared at the advancing side SZ/TMAZ boundary, which increased in severity with increasing welding speed. In this region of machine settings, summarized in FIG. 25, flow stress values were observed to be the highest of all welds made, in the range of 50 to 60 MPa (FIG. 34 and FIG. 38), and the energy density was observed to be very low, in the range of 2.1 to 1.6 W/mm\hat{ }2. The implication here is that the peak temperature is very low, resulting in high flow stress, and the temperature distribution is low (low energy density). Considering that the voids were located on the extreme advancing side of the SZ, combined with the low peak temperature and possibly low temperature just outside of the SZ, suggest the possibility of cooling-interrupted coalescence of material as it is flowing forward to fill the advancing side void behind the probe. The irregular, jagged shape of the voids suggest thread-formed material cooling before full consolidation is achieved. As the welding speed is further increased, the appearance of voids in the root of the SZ suggest that cooling from the anvil and possibly low local surface velocity at the tool/workpiece interface, caused voids to appear there.

In this work, friction stir welds were systematically made in thick-section 7075-T6 to explore the correlation between the basic machine settings of spindle speed and travel speed, weld quality and to explore correlation of welding quality with unit-area analysis techniques. It was generally found that the average flow stress at the tool/workpiece interface, calculated from the spindle torque and welding tool geometry, was a reasonable predictor of weld quality in terms of volumetric defects. Welds in the range of 55 to 30 MPa were found to be volumetrically sound. Welds with lower average flow stress exhibited volumetric defects in the upper SZ, which increased in severity with decreasing flow stress. Welds with average flow stress above 55 MPa exhibited defects in the advancing side SZ/TMAZ boundary and SZ root, which it is speculated is due to cooling-interrupted coalescence of material as it is pushed forward to fill the gap behind the pin on the advancing side. More experimental work, possibly using stop-action methods, may explain these defects in greater detail.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

What is claimed is:

1. A friction stir welding apparatus, comprising:
a friction stir welding (FSW) unit configured to rotate a welding tool about a spindle axis at a spindle rate of rotation (Sᵣ₋ₒ₋ₜ), cause the welding tool to travel in a direction perpendicular to the spindle axis at a travel speed (T_{speed}), and cause the welding tool to impart a downward force on a workpiece at a plunge force (P_{force});
a sensor module configured to detect:
a spindle torque and generate a spindle torque signal representative of the spindle torque;
a control module configured to receive the spindle torque signal and:
generate:
a command signal to modulate the Sᵣ₋ₒ₋ₜ, the T_{speed}, and/or the P_{force} in response to the detected spindle torque; and/or
a recommendation signal to modulate the Sᵣ₋ₒ₋ₜ, the T_{speed}, and/or the P_{force} in response to the detected spindle torque;
the control module is configured to generate the command signal and/or the recommendation signal to modulate the Sᵣ₋ₒ₋ₜ, the T_{speed}, and/or the P_{force} so that the detected spindle torque:
stays within a range of spindle torque values.

2. The friction stir welding apparatus of claim 1, wherein:
the range of spindle torque values is defined by an upper threshold spindle torque value and a lower threshold spindle torque value.

3. The friction stir welding apparatus of claim 2, wherein:
the upper threshold spindle torque value is a spindle torque value corresponding to a flow stress for a material of the workpiece above which a defect in the workpiece is generated; and
the lower threshold spindle torque value is a spindle torque value corresponding to a flow stress for a material of the workpiece below which a defect in the workpiece is generated.

4. The friction stir welding apparatus of claim 3, wherein:
maintaining the detected spindle torque within the range defined by the upper threshold spindle torque value and the lower threshold spindle torque value generates no defects in the material of the workpiece due to flow stress.

5. The friction stir welding apparatus of claim 2, wherein:
the range of spindle torque values is defined by an upper threshold parameter value and a lower threshold parameter value;
the upper threshold parameter value is a measurement that is proportional to spindle torque above which a defect in the workpiece is generated; and
the lower threshold spindle torque value is a measurement that is proportional to spindle torque below which a defect in the workpiece is generated.

6. The friction stir welding apparatus of claim 1, wherein:
the modulation of the Sᵣ₋ₒ₋ₜ, the T_{speed}, and/or the P_{force} includes:
increasing Sᵣ₋ₒ₋ₜ, decreasing T_{speed}, and/or decreasing P_{force} to decrease the detected spindle torque; and/or
decreasing Sᵣ₋ₒ₋ₜ, increasing T_{speed}, and/or increasing P_{force} to increase the detected spindle torque.

7. The friction stir welding apparatus of claim 6, wherein:
the modulation of the Sᵣ₋ₒ₋ₜ, the T_{speed}, and/or the P_{force} includes:
increasing/decreasing one or more of the Sᵣ₋ₒ₋ₜ, the T_{speed}, and/or the P_{force} while holding one or more constant;
increasing/decreasing one or more of the Sᵣ₋ₒ₋ₜ, the T_{speed}, and/or the P_{force} while allowing one or more to be uncontrolled;
increasing/decreasing any number of the Sᵣ₋ₒ₋ₜ, the T_{speed}, and/or the P_{force} simultaneously;
increasing/decreasing any number of the Sᵣ₋ₒ₋ₜ, the T_{speed}, and/or the P_{force} in a successive order;
increasing/decreasing any one of the Sᵣ₋ₒ₋ₜ, the T_{speed}, and/or the P_{force} as a primary modulation and one or more as a secondary modulation;
increasing/decreasing any one of the Sᵣ₋ₒ₋ₜ, the T_{speed}, and/or the P_{force} as a gross modulation and one or more as a fine tune modulation;
increasing/decreasing any one or more of the Sᵣ₋ₒ₋ₜ, the T_{speed}, and/or the P_{force} within a set modulation range; and/or
increasing/decreasing any one or more of the Sᵣ₋ₒ₋ₜ, the T_{speed}, and/or the P_{force} as a function of another.

8. The friction stir welding apparatus of claim 1, wherein the control module is configured to:
receive the spindle torque signal and generate the command signal in a feedback loop; and/or
receive the spindle torque signal and generate the recommendation signal in a feedback loop.

9. The friction stir welding apparatus of claim 1, wherein:
the sensor module configured to also detect an in-plane force acting upon the welding tool when the welding tool is caused to perform work on a workpiece, the in-plane force being a force normal to the spindle axis, wherein the sensor module generates an in-plane force signal representative of the in-plane force;
the control module is configured to receive the in-plane force signal and:
generate:
a command signal to modulate the T_{speed} in response to the in-plane force signal; and/or
a recommendation signal to modulate the T_{speed} in response to the in-plane force signal.

10. The friction stir welding apparatus of claim 9, wherein:
the control module is configured to set one or more limits on the T_{speed} or modulation of the T_{speed} based on the detected in-plane force.

11. A friction stir welding apparatus, comprising:
a friction stir welding (FSW) unit configured to rotate a welding tool about a spindle axis at a spindle rate of rotation (Sᵣ₋ₒ₋ₜ), cause the welding tool to travel in a direction perpendicular to the spindle axis at a travel speed (T_{speed}), and cause the welding tool to impart a downward force on a workpiece at a plunge force (P_{force});
a sensor module configured to detect:
a spindle torque and generate a spindle torque signal representative of the spindle torque;
a control module configured to receive the spindle torque signal and:
generate:
a command signal to modulate the P_{force} in response to the detected spindle torque; and/or
a recommendation signal to modulate the P_{force} in response to the detected spindle torque;
the control module is configured to generate the command signal and/or the recommendation signal to modulate the P_{force} so that one or more of the following is held at a constant value:
an excess shoulder pressure;
a measurement parameter that is proportional to P_{force};
a measurement parameter that is proportional to spindle torque; or
a measurement parameter that is proportional to a dimension of the welding tool, wherein:
excess shoulder pressure is achieved by maintaining a shoulder pressure at a fixed value greater than flow stress;
shoulder pressure=(P_{force}/shoulder area)−flow stress;
shoulder area is an area of a shoulder of the welding tool; and
flow stress is a measure of an average contact shear stress at an interface between the welding tool and the workpiece.

12. A friction stir welding apparatus, comprising:
a friction stir welding (FSW) unit configured to rotate a welding tool about a spindle axis at a spindle rate of rotation (Sᵣ₋ₒ₋ₜ), cause the welding tool to travel in a direction perpendicular to the spindle axis at a travel speed (T_{speed}), and cause the welding tool to impart a downward force on a workpiece at a plunge force (P_{force});
a sensor module configured to detect:
a spindle torque and generate a spindle torque signal representative of the spindle torque;
an in-plane force and generate an in-plane signal representative of the in-plane force; and
a P_{force}, used to calculate an excess shoulder pressure and generate an excess shoulder pressure signal representative of the excess shoulder pressure; and
a control module configured to receive the spindle torque signal, the in-plane signal, and/or the excess shoulder pressure signal and:
generate:
a command signal to modulate the Sᵣ₋ₒ₋ₜ, the T_{speed}, and/or the P_{force} in response to the detected spindle torque, the detected in-plane force, and/or the detected excess shoulder pressure; and/or
a recommendation signal to modulate the Sᵣ₋ₒ₋ₜ, the T_{speed}, and/or the P_{force} in response to the detected spindle torque the detected in-plane force, and/or the detected excess shoulder pressure;
the control module is configured to generate the command signal and/or the recommendation signal to modulate the Sᵣ₋ₒ₋ₜ, the T_{speed}, and/or the P_{force} so that:
the detected spindle torque stays within a range of spindle torque values; and
the detected in-plane force stays within a range of in-plane force values.

13. The friction stir welding apparatus of claim 12, wherein the control module is configured to:
receive the spindle torque signal, the in-plane signal, and/or the excess shoulder pressure signal, and generate the command signal in a feedback loop; and/or
receive the spindle torque signal, the in-plane signal, and/or the excess shoulder pressure signal, and generate the recommendation signal in a feedback loop.

14. The friction stir welding apparatus of claim 13, wherein the control module is configured to:
hold one or more of the Sᵣ₋ₒ₋ₜ, the T_{speed}, and the P_{force} constant while modulating one or more of the Sᵣ₋ₒ₋ₜ, the T_{speed}, and the P_{force}.

15. The friction stir welding apparatus of claim 13, wherein the control module is configured to:
increase the T_{speed} to generate a predetermined in-plane force, modulate the Sᵣ₋ₒ₋ₜ and/or the P_{force} while holding the T_{speed} at a value that maintains the predetermined in-plane force.

16. The friction stir welding apparatus of claim 15, wherein:
the predetermined in-plane force is a maximum in-plane force that will not damage the welding tool, will not result in premature failure of the welding tool, and/or achieve optimum weld productivity.

17. The friction stir welding apparatus of claim 1, wherein:
the control module is configured implement a closed loop control to receive the spindle torque signal and generate the command signal and/or the recommendation signal.

18. The friction stir welding apparatus of claim 11, wherein:
the control module is configured to implement a closed loop control to receive the spindle torque signal and generate the command signal and/or the recommendation signal under a closed loop control operation.

19. The friction stir welding apparatus of claim 12, wherein:
the control module is configured to implement a closed loop control to receive the spindle torque signal and generate the command signal and/or the recommendation signal under a closed loop control operation.

20. A method for controlling a friction stir weld, the method comprising:
initiating spindle speed, travel speed, and plunge force for a welding tool that is engaged with a workpiece;
controlling flow stress experienced at an interface between the welding tool and the workpiece by:
modulating spindle speed only;
modulating spindle speed and travel speed, each being modulated within predefine operating limits, and each being modulated independently of the other;
modulating spindle speed and travel speed, each being modulated within predefine operating limits, and modulation of one is dependent on modulation of the other by imposing a relationship between spindle speed modulation and travel speed modulation; or
manipulating plunge axis position to modulate plunge force.

21. The method of claim 20, wherein:
controlling flow stress involves modulating spindle speed, travel speed, and/or plunge force to maintain a constant spindle torque.

22. The method of claim 21, further comprising:
maintaining a constant workpiece temperature at the interface between the welding tool and the workpiece by maintaining the constant spindle torque.

23. A friction stir welding apparatus, comprising:
a friction stir welding (FSW) unit configured to rotate a welding tool about a spindle axis at a spindle rate of rotation (Sᵣ₋ₒ₋ₜ) and at a spindle pitch (S_{pitch}), cause the welding tool to travel in a direction perpendicular to the spindle axis at a travel speed (T_{speed}), and cause the welding tool to impart a downward force on a workpiece at a plunge force (P_{force});
a sensor module configured to detect:
a spindle torque and generate a spindle torque signal representative of the spindle torque, a welding tool temperature and generate a welding tool temperature signal representative of the welding tool temperature, and/or a flow stress and generate a flow stress signal representative of the flow stress;
a control module configured to receive the spindle torque signal, the welding tool temperature signal, and/or the flow stress signal and:
generate:
a command signal to modulate the Sᵣ₋ₒ₋ₜ, the T_{speed}, the P_{force}, and/or the S_{pitch} in response to the detected spindle torque, welding tool temperature, and/or flow stress; and/or
a recommendation signal to modulate the Sᵣ₋ₒ₋ₜ, the T_{speed}, the P_{force}, and/or the S_{pitch} in response to the detected spindle torque, welding tool temperature, and/or flow stress;
the control module is configured to generate the command signal and/or the recommendation signal to modulate the Sᵣ₋ₒ₋ₜ, the T_{speed}, the P_{force}, and/or the S_{pitch} so that the detected spindle torque stays within a range of spindle torque values, a range of welding tool temperature values, and/or a range of flow stress values.

24. The friction stir welding apparatus of claim 23, wherein:
the control module is configured to modulate the Sᵣ₋ₒ₋ₜ, the T_{speed}, the P_{force}, and/or the S_{pitch} by holding any one or combination of them at a constant value;
the control module is configured to modulate the Sᵣ₋ₒ₋ₜ, the T_{speed}, the P_{force}, and/or the S_{pitch} by maintaining any one or combination of them within a range of values; or
the control module is configured to modulate two or more of the Sᵣ₋ₒ₋ₜ, the T_{speed}, the P_{force}, and/or the S_{pitch} in a constant ratio with respect to each other.

25. The friction stir welding apparatus of claim 24, wherein:
the range of values for the Sᵣ₋ₒ₋ₜ is a range defined by a Sᵣ₋ₒ₋ₜ setpoint, a Sᵣ₋ₒ₋ₜ minimum, and a Sᵣ₋ₒ₋ₜ maximum;
the range of values for the T_{speed} is a range defined by a T_{speed} setpoint, a T_{speed} minimum, and a T_{speed} maximum;
the range of values for the P_{force} is a range defined by a P_{force} setpoint, a P_{force} minimum, and a P_{force} maximum; and
the range of values for the S_{pitch} is a range defined by a S_{pitch} setpoint, a S_{pitch} minimum, and a S_{pitch} maximum.

26. The friction stir welding apparatus of claim 23, wherein:
the control module is configured to calculate a temperature at an interface between the welding tool and the workpiece based on the measured spindle torque, welding tool temperature, and flow stress.

27. The friction stir welding apparatus of claim 26, wherein:
the control module is configured to monitor changes in thermal boundary conditions based on the temperature at the welding tool/workpiece interface; and
the control module is configured to modulate the Sᵣ₋ₒ₋ₜ, the T_{speed}, the P_{force}, and/or the S_{pitch} to maintain weld quality with changes in thermal boundary conditions.
